(19) United States
(12) Patent Application Publication
(10) Pub. No.: US 2023/0329476 A1
(43) Pub. Date: Oct. 19, 2023

(54) Cartridge System, Beverage Preparation Machine, and Process For Manufacturing a Cartridge System

(71) Applicant: Freezio AG, Amriswil (CH)

(72) Inventors: Marc Krüger, Bergisch Gladbach (DE); Günter Empl, Bergisch Gladbach (DE)

(21) Appl. No.: 18/025,739

(22) PCT Filed: Oct. 21, 2021
(86) PCT No.: PCT/EP2021/079270

§ 371 Date: Mar. 10, 2023

(30) Foreign Application Priority Data
Oct. 22, 2020 (DE) 10 2020 213 332.8
Oct. 22, 2020 (DE) 10 2020 213 333.6
Dec. 4, 2020 (DE) 10 2020 215 357.4
Dec. 4, 2020 (DE) 10 2020 215 361.2
Mar. 11, 2021 (DE) 10 2021 202 394.0
Mar. 11, 2021 (DE) 10 2021 202 395.9
Mar. 11, 2021 (DE) 10 2021 202 396.7

(51) Int. Cl. A47J 31/40; B67D 1/08; B67D 1/00

(52) U.S. Cl. CPC A47J 31/407; B67D 1/0801; B67D 1/0079; B67D 2001/0812

(57) ABSTRACT

Proposed is a cartridge system for making a beverage, the cartridge system being insertable into a beverage preparation machine and comprising: a cartridge that includes a reservoir filled with a beverage substance; and a cartridge receptacle that is connected to the cartridge; the cartridge receptacle includes a mixing chamber fluidically connectable to the reservoir, and a fluid feed line extending into the mixing chamber; the cartridge has a cartridge wall; characterized in that the cartridge wall includes a flange for attaching a sealing element.

### PRIOR ART

The present invention starts from a cartridge system for making a beverage, wherein the cartridge system can be inserted into a beverage preparation machine, has a cartridge, which comprises a reservoir filled with a beverage substance, and has a cartridge receptacle connected to the cartridge, wherein the cartridge receptacle has a mixing chamber, which can be brought into fluidic connection with the reservoir, and a fluid feed opening into the mixing chamber, wherein the cartridge has a cartridge wall.

Such systems are known from the prior art, for example from WO 2017/121 802 A1, WO 2017/121 801 A1, WO 2017/121 801 A1, WO 2017/121 799 A1, WO 2017/121 798 A1, WO 2017/121 797 A1, WO 2017/121 796 A1 and WO 2019/002 293 A1 and are used for making beverages from pre-portioned cartridges. The production of beverages with such systems is extremely convenient for the user since he merely has to insert a cartridge and press a start button. The beverage preparation machine then undertakes the production thereof in a fully automated manner, i.e., in particular, the beverage substance is blended with a predetermined quantity of liquid, in particular cold and carbonated water, and conveyed into a drinking vessel. In this way, in particular mixed drinks can be produced much more easily, quickly and with less effort for the user. The user can choose from a large number of different cartridges here, and so he can produce different beverages as desired.

It is a challenge to store the beverage substance safely and stably in the cartridge, especially also before the use of the cartridge system in the beverage preparation machine. It is important in this context that the freshness and quality of the beverage substance is preserved. At the same time, a reliable and reproducible beverage making process should be made possible by the cartridge system.

### SUMMARY OF THE INVENTION

It is therefore an object of the present invention to provide a cartridge system which can be used in a beverage preparation machine for making a beverage and with which improved storage of the beverage substance and/or high-quality beverage preparation is possible.

This object is achieved by a cartridge system as claimed in claim 1.

The cartridge system according to the invention has the advantage over the prior art that advantageous mounting of a sealing element for sealing the reservoir or a main body of the cartridge is made possible. The sealing element preferably ensures that the beverage substance remains within the reservoir before the start of the beverage making process and is hermetically sealed there for a long shelf life and a constant aroma. With the aid of the flange, the sealing element can be mounted on the cartridge with high stability and leaktightness, and therefore even high internal pressures can be enclosed in the cartridge with the aid of the flange and the sealing element. The beverage substance, which is, in particular, liquid, can thus be enclosed in the reservoir under a higher pressure. It is thus possible to store beverage substances with a higher carbonic acid content in the reservoir without there being the risk that the seal of the reservoir, that is to say in particular the sealing element, will leak and gas and/or liquid will escape, for example in the event of shocks during transportation or storage of the cartridge system, on account of the carbonic acid. The higher carbonic acid content in turn has a positive effect both on the taste of the beverage to be made and on the minimum shelf life of the cartridge. In order to maintain their freshness and quality, some beverage substances require particularly high internal pressures in the reservoir of the cartridge, and these are provided by pre-carbonation, for example. It is furthermore an advantage of the cartridge system according to the invention that the reservoir can be emptied with a comparatively high pressure during the beverage making process without unwanted leaks occurring, for example in the region where the sealing element is secured on the cartridge. This makes it possible to reduce the extraction time without any risk of impairing the taste of the beverage to be made. At the same time, it is advantageously possible for the flange according to the invention not to have any disadvantageous effect on the preparation speed of the beverage in the beverage preparation machine.

According to the invention, a sealing element can be crimped around the flange in a particularly advantageous manner, resulting in particularly pressure-stable sealing. This is particularly advantageous for beverage substances which are enclosed in the reservoir at a high internal pressure. According to the invention, it is furthermore advantageously possible for an enlarged region for the mounting of a sealing element to be formed by the flange. This is advantageous, for example, for the mounting of a sealing element designed as a sealing film.

The cartridge preferably comprises glass. The cartridge preferably has a main body made of glass. As a preferred option it is conceivable for the entire cartridge to be produced from glass and, as a particular preference, to be designed as a glass cartridge and/or glass bottle.

Alternatively, it is conceivable to produce the cartridge completely or partially from plastic.

Alternatively, it is conceivable for the cartridge to have a main body which is produced from aluminum and which, in its typical wall region, preferably has a wall thickness of between 0.01 and 0.5 millimeters, preferably between 0.01 and 0.2 millimeters, particularly preferably between 0.03 and 0.1 millimeters and very particularly preferably substantially 0.05 millimeters, in particular with an error tolerance of at most 15%. A main body made of aluminum can be produced, for example, by deep-drawing or extrusion.

The cartridge is preferably designed in such a way that it can withstand an internal pressure of up to 12 bar, preferably up to 10 bar, particularly preferably up to 8 bar and very particularly preferably up to 6 bar, without bursting (at a temperature of 20° C. and an external pressure of 1 bar). Alternatively, it is also conceivable for the cartridge to have a pressure resistance of less than 6 bar, thereby enabling costs to be reduced. Cartridges with low pressure resistance can be used in particular for concentrates containing little or no CO₂. The reservoir preferably comprises a volume of between 10 and 500 milliliters, particularly preferably between 30 and 90 milliliters and very particularly preferably substantially 60 milliliters. In particular, the cartridge system has a liquid beverage substance which preferably contains carbonic acid. It is alternatively conceivable for the liquid beverage substance not to contain carbonic acid. As a particular preference, the liquid beverage substance comprises a beverage concentrate, in particular a syrup.

It is conceivable according to the invention for the cartridge receptacle to be understood as a mixing cap of the cartridge system.

Advantageous configurations and developments of the invention can be gathered from the dependent claims, and from the description with reference to the drawings.

According to one preferred embodiment of the present invention, provision is made for the flange to be designed as a mouth region of the cartridge wall, in particular at an edge of the cartridge wall. The flange is thus preferably designed as an end region of the cartridge wall. An upper side of the flange, which is, in particular, a side of the flange facing away from the main region of the cartridge and/or from a cartridge base, preferably forms an end face, in particular, an annular end face, in the mouth region of the cartridge. The end face can be formed perpendicularly to a central axis of extent of the cartridge or can have an angle other than 90° to the central axis of extent. It is conceivable, for example, for the upper side and/or the end face of the flange to fall away in the radial direction from the inside to the outside (that is to say with increasing distance from the central axis of extent) in the direction of a cartridge base of the cartridge, in particular with an opening angle of between 15° and 0° with respect to a radial axis, preferably with an opening angle of between 10° and 0°, particularly preferably with an opening angle of 7°. It is conceivable for the upper side and/or the end face of the flange not to fall away and thus to have an angle of 0° with respect to the radial axis. It is alternatively conceivable for the upper side and/or the end face of the flange to fall away in the radial direction from the outside to the inside (that is to say with a decreasing distance from the central axis of extent) in the direction of the cartridge base of the cartridge, in particular with an opening angle of between 15° and 0° with respect to a radial axis, preferably with an opening angle of between 10° and 0°, particularly preferably with an opening angle of 7°. The radial axis points in the radial direction and is perpendicular to the central axis of extent of the cartridge. The radial axis is thus, in particular, arranged perpendicularly to an axial direction of the cartridge.

According to one preferred embodiment of the present invention, provision is made for the flange to be designed as a radially outward-projecting region of the cartridge wall. The flange thus comprises a protrusion of the cartridge wall which projects radially outward perpendicularly to the central axis of extent of the cartridge.

According to one preferred embodiment of the present invention, provision is made for the flange to be formed in a fully circumferential manner on the cartridge wall, in particular around the entire circumference of the cartridge wall. As a particular preference, it is conceivable according to one embodiment of the present invention for the flange to extend all the way around an opening in the cartridge. The sealing element is provided for closing the opening of the cartridge and, for this purpose, can be secured on the cartridge with the aid of the flange. As a preferred option, it is conceivable for the opening to be of circular design. As a preferred option, it is possible for the opening to have a diameter of between 10 and 50 mm, particularly preferably between 15 and 30 mm, more particularly preferably of at least 18 mm (in particular with an error tolerance of at most 15%). Alternatively, it is also conceivable for the opening to have a diameter of less than or equal to 10 mm or greater than or equal to 50 mm.

According to one preferred embodiment of the present invention, provision is made for the flange to be formed with the aid of a thickened region of the cartridge wall. The cartridge wall thus preferably has a greater wall thickness in the region of the flange than in a region adjacent to the flange.

According to one embodiment of the present invention, it is possible for the outer diameter of the flange, in particular from one outer side of the flange to the opposite outer side of the flange, to be between 15 and 55 mm, preferably between 20 and 35 mm, particularly preferably at most 29 mm (with, in particular, a maximum manufacturing tolerance of 15%).

According to one embodiment of the present invention, it is possible for the flange to have an indentation on its outer side, in particular an indentation which runs around in the circumferential direction. In particular, the indentation is designed as a radial thinning of the flange. Such thinning is advantageous particularly if the cartridge or the cartridge wall is produced from or with the aid of plastic. It is particularly advantageously conceivable for the two rings of the flange which are formed by the indentation of the flange (in particular with one ring being arranged above the indentation and one ring being arranged below the indentation) to be reinforced by one or more vertical webs in order to be able to advantageously absorb crimping forces.

According to one preferred embodiment of the present invention, provision is made for the cartridge to comprise a main body, in particular of cup-shaped design, wherein the main body is formed with the aid of the cartridge wall, which is closed on one side by a cartridge base, wherein the main body comprises, in particular, the reservoir. The cartridge wall and the cartridge base are, in particular, of integral design. As a preferred option, it is conceivable for the cartridge wall to be of cylindrical design at least in a main region of the cartridge wall. The cartridge wall and the cartridge base can preferably be formed by a glass bottle. It is alternatively conceivable for the cartridge wall and the cartridge base to be formed by a plastic or a metal.

According to one preferred embodiment of the present invention, provision is made for the cartridge wall to comprise a secondary region which is arranged adjacent to the flange in the direction of the cartridge base, wherein the cartridge wall has a smaller wall thickness in the secondary region than in the region of the flange. The flange thus preferably projects outward in the radial direction beyond the secondary region and forms a widened mouth region of the cartridge. Advantageous mounting of the sealing element is thereby possible. In particular, a particularly stable connection can be achieved by crimping the sealing element around the flange.

According to one embodiment of the present invention, it is conceivable for an upper side of the flange facing away from the cartridge base and/or an end face of the flange arranged on the upper side to merge into an inner side of the cartridge at its radially inner end with the aid of a first radius of curvature “M” and optionally with the aid of an additional straight region and/or with the aid of a first chamfer. The first radius of curvature M and/or the first chamfer particularly advantageously prevent/prevents the sealing element from accidentally tearing open in this region since there is thus no sharp edge which can come into contact with the sealing element.

According to one embodiment of the present invention, it is conceivable for the upper side and/or the end face of the flange to merge into an outer side of the flange in its radially outer end with a second radius of curvature “N” and/or with the aid of a second chamfer, the outer side extending circumferentially around the cartridge. Crimping of a sealing element around the flange can be improved in a particularly advantageous manner by the second radius of curvature N and/or the second chamfer.

According to one embodiment of the present invention, it is conceivable for the outer side of the flange to merge into a lower side of the flange at its lower end, in particular at its end opposite the upper side of the flange, with a third radius of curvature “O” and/or with the aid of a third chamfer. It is advantageously possible for the crimping of a sealing element around the flange to be improved in a particularly advantageous manner by the third radius of curvature O and/or the third chamfer.

According to one embodiment of the present invention, it is conceivable for the lower side of the flange to have a lower opening angle “K” of between 20° and 90°, inclusive, to the central axis of extent of the cartridge, preferably between 30° and 80°, inclusive, particularly preferably between 50° and 70°, inclusive (in particular with a manufacturing tolerance of at most 15%). It is conceivable, for example, for the lower opening angle “K” to be 60° (with, in particular, a manufacturing tolerance of at most 15%).

According to one embodiment of the present invention, it is conceivable for the secondary region of the cartridge wall to be formed adjacent to the lower side of the flange. It is conceivable for a fourth radius of curvature “P” and/or a fourth chamfer to be formed as a transition between the lower side of the flange and the secondary region.

According to one preferred embodiment of the present invention, provision is made for the cartridge wall to have a connecting means, in particular an encircling connecting means, for connecting the cartridge to the cartridge receptacle, wherein the connecting means comprises, in particular, one or more latching grooves, and/or one or more latching beads, and/or one or more undercuts, and/or an external thread. Thus, a stable and low-cost connection between the cartridge and the cartridge receptacle is preferably achieved. The flange for mounting the sealing element is, in particular, an additional element which is formed separately from the connecting means and which is particularly advantageously not part of the connecting means. As a particularly advantageous possibility, the connecting means, in particular the latching means, comprises a flattened region, with the aid of which a twist prevention means for the cartridge and the cartridge receptacle is formed. Since the flange is a region separate from the connecting means, it is nevertheless advantageously possible, despite such a flattening of the connecting means, to use a circular crimp cap as a sealing element, which is crimped around the flange, the latter being, in particular, circular. It is conceivable for the cartridge to have a flattened area over its entire height or for it to be of cylindrical design (or with a circular base area over its entire height). It is alternatively conceivable for the cartridge to have the flattened area only over part of its height, for example only in the region of the main body of the cartridge, wherein a mouth region of the cartridge is of circular design, in particular around the opening of the cartridge closed by the sealing element. A combination is also conceivable. It is conceivable, for example, for a partial region of the cartridge to be of cylindrical design and for a further partial region to be formed with a flattened portion. It is conceivable for the connecting means to have a flattened portion and for the rest of the cartridge to be partially or completely cylindrical or likewise partially or completely flattened.

According to one preferred embodiment of the present invention, provision is made for the connecting means to be formed at a distance from the flange, wherein the connecting means is arranged offset from the flange, in particular in the direction of the cartridge base.

According to one preferred embodiment of the present invention, provision is made for the connecting means to be arranged adjacent to the secondary region, offset in the direction of the cartridge base. The secondary region, which in particular has a smaller wall thickness or thickness (in the radial direction) than the flange, is thus preferably arranged between the connecting means and the flange and separates the flange from the connecting means. The flange is preferably provided for mounting the sealing element, while the connecting means is provided for producing a connection to the cartridge receptacle.

According to one preferred embodiment of the present invention, provision is made for the connecting means for connecting the cartridge to the cartridge receptacle to comprise the flange and/or for the flange to comprise the connecting means for connecting the cartridge to the cartridge receptacle. Thus, it is, in particular, conceivable for the flange, which is provided for mounting the sealing element on the cartridge, to be part of the connecting means. It is conceivable, for example, for the connecting means to be formed completely or partially by the flange.

According to one preferred embodiment of the present invention, provision is made for the cartridge receptacle to comprise a mating connecting means, in particular complementary to the connecting means, in particular one or more further latching grooves, and/or one or more further latching beads, and/or one or more further undercuts, and/or an internal thread, wherein the mating connecting means is preferably connected to the connecting means positively, nonpositively and/or materially. Alternatively or in addition, it is conceivable for a wall of the cartridge receptacle to be crimped around the cartridge. As a particularly advantageous possibility, both the connecting means and the mating connecting means each have a flattened region, with the aid of which a twist prevention means for the cartridge and the cartridge receptacle is formed. In the case where the flange is a region separate from the connecting means, it is nevertheless advantageously possible, despite such a flattening of the connecting means, to use a circular crimp cap as a sealing element, which is crimped around the flange, the latter being, in particular, circular.

According to one embodiment of the present invention, it is conceivable to embody the cartridge and/or the cartridge receptacle with a flattened portion or without a flattened portion. It is possible, for example, to embody the cartridge and/or the cartridge receptacle in each case on their circumference, in particular in the circumferential direction, with a flattened portion, with the result that a relative orientation of the cartridge, intermediate cap and/or cartridge receptacle is predetermined by the flattened portion. In this way, it is possible to achieve a twist prevention means, for example. Alternatively, the cartridge and/or the cartridge receptacle can also each be designed without a flattened portion in the circumferential direction, being, in particular, of round design.

According to one embodiment of the present invention, it is, in particular, conceivable for the cartridge receptacle to be screwed onto the cartridge by means of the internal thread and the external thread. In this case, the screw connection is preferably designed in such a way that screwing on with subsequent latching is made possible, with the result that subsequent unscrewing is prevented or made more difficult and/or a fixed relative orientation of the cartridge receptacle with respect to the cartridge can be achieved by means of the latching. For this purpose, a twist prevention means can be formed on the cartridge and/or the cartridge receptacle, for example a vertical groove and/or a vertical projection and/or a vertical rib and/or one or more latching hooks on the circumference.

According to one preferred embodiment of the present invention, provision is made for the cartridge to have the sealing element, wherein, in particular, the main body is closed off by the sealing element on its side opposite the cartridge base in an initial state of the cartridge system. The sealing element advantageously ensures that the beverage substance remains within the reservoir before the start of the beverage making process and is hermetically sealed there for a long shelf life and a constant aroma.

According to one preferred embodiment of the present invention, provision is made for the sealing element to be crimped, adhesively bonded, sealed, welded and/or screwed to the cartridge with the aid of the flange. In particular, the sealing element is crimped, adhesively bonded, sealed and/or welded to the cartridge with the aid of a peripheral securing region of the sealing element and with the aid of the flange. Particularly pressure-stable securing of the sealing element on the cartridge can be achieved here by crimping the sealing element around the flange, thus enabling comparatively high internal pressures to be enclosed reliably in the interior of the cartridge even over long periods of time. Thus, a sealing element crimped on the flange results in particular advantages. However, it is also conceivable for connecting methods other than crimping to be used for mounting a sealing element on the cartridge with the aid of the flange. It is thus possible, for example, for the sealing element to be adhesively bonded or sealed or welded to the flange. This results in a particularly advantageous flexibility in the use of the cartridge. In particular, it is conceivable for a cartridge to be able to be combined with different sealing elements (and/or methods for mounting the sealing elements on the cartridge) without a structural change in the cartridge being necessary. This increases the possible uses of the cartridge or of the cartridge system as well as scalability in a particularly cost-effective manner.

According to one preferred embodiment of the present invention, provision is made for the sealing element to comprise a crimp cap.

According to one preferred embodiment of the present invention, provision is alternatively made for the crimp cap to comprise a metal, preferably aluminum. Alternatively or in addition, it is conceivable for the crimp cap to comprise plastic and/or tinplate and/or some other sheet metal.

According to one preferred embodiment of the present invention, provision is made for the crimp cap to be secured on the flange of the cartridge, in particular in an initial state of the cartridge system, wherein the crimp cap is crimped, in particular, to the flange of the cartridge. In this case, a securing region of the crimp cap is preferably crimped around the flange. A particularly advantageous crimped connection can thus be formed with the aid of the flange. A crimped connection is particularly advantageous if an overpressure is formed in the reservoir of the cartridge, in particular on account of pre-carbonation of the beverage substance. It is conceivable, for example, for an overpressure of several bar, for example up to twelve bar, up to eleven bar or up to five bar, to be formed in the cartridge. The closure, formed by the sealing element, of the main body of the cartridge must reliably withstand such an overpressure. For this purpose, crimping of the sealing element around the flange of the cartridge is particularly advantageous since such a connection can also enclose such a high overpressure within the main body of the cartridge reliably and for a comparatively long time. An overpressure due to pre-carbonation can be used for preserving and keeping fresh different beverage substances in the cartridge. Furthermore, pre-carbonation of the beverage substance and enclosure of the beverage substance within the cartridge with a corresponding overpressure can be advantageous for the taste of the beverage produced from the beverage substance. It is possible, in particular as an alternative to forming the sealing element with the aid of a crimp cap, for the sealing element to be formed with the aid of or by a screw cap, wherein the screw cap preferably has a seal and a bore and/or punching for the piercing spike. The mouth region of the cartridge preferably has a thread for screwing on the screw cap. It is conceivable for the screw cap to be screwed onto the cartridge, the cartridge receptacle preferably being secured on the cartridge and/or the screw cap after the screw cap has been screwed on. The screw cap can comprise plastic and/or metal, for example.

According to one embodiment of the present invention, it is conceivable for the sealing element to comprise a plastic cap or to be designed as a plastic cap. It is possible, for example, for the plastic cap to be snapped onto the cartridge, in particular with the aid of the flange, or to be secured on the flange by thermal deformation, for example with the aid of ultrasound.

The plastic cap preferably comprises a bore or punching with a sealing film which is applied, sealed or welded on the inside or on the outside. If the sealing film is applied on the inside, it is conceivable, after the plastic cap has been applied to the cartridge, for the sealing film to be additionally sealed (for example welded) in both directions in order to prevent water ingress between the plastic cap and the sealing film—provided on both sides with a sealing layer—during pasteurization.

According to one embodiment of the present invention, it is conceivable for the plastic cap of the sealing element to be formed with the aid of injection molding. The plastic cap is thus preferably an injection-molded part. It is conceivable here for the plastic cap to be designed as a crimp cap, latching cap or screw cap. It is conceivable for the plastic cap to have a weakening for the passage of the piercing spike. The weakening is preferably a region of the plastic cap with reduced wall thickness or thickness. The weakening is preferably designed in such a way that the piercing spike can open and/or penetrate the sealing element in the region of this weakening. It is conceivable for this weakening to be produced during the formation of the plastic cap, in particular during injection molding, as a thinned region of the plastic cap. Thus, as a particular preference, the weakening is produced during the injection molding of the plastic cap, thereby eliminating the need for any further post-processing of the plastic cap to produce the weakening.

According to one embodiment of the present invention, it is conceivable for the weakening to be designed as a full-area, in particular circular-area, weakening in the plastic cap. Alternatively, other geometries are also conceivable for the weakening. It is conceivable, for example, for the weakening to be designed in the form of a ring or as a circular line. According to one embodiment of the present invention, it is possible for a sealing layer, in particular a coat and/or a laminated or coextruded plastic, preferably comprising polypropylene and/or another plastic, to be arranged on a lower side of the sealing element, preferably of the crimp cap, which is oriented in the direction of the cartridge. In particular, the sealing layer is arranged between the flange and the sealing element. With the aid of the sealing layer, advantageous sealing is possible. It is optionally possible in addition or as an alternative for a seal to be arranged between the sealing element and the flange, in particular the end face of the flange. It is conceivable, for example, for the seal to be of annular design. Alternatively, it is conceivable for the seal to be designed as a full seal, that is to say in particular as a continuous, preferably disk-shaped seal. With the aid of the seal, additionally improved sealing is possible.

According to one embodiment of the present invention, it is conceivable for the cartridge to have a coating, in particular comprising a metal and/or a plastic, in particular in its mouth region, preferably on the flange. It is conceivable, for example, for the coating to comprise tin tetrachloride, one or more plastics and/or other materials which lead to an improvement in the sealing properties. It is conceivable for the coating to be applied to the cartridge, in particular to the mouth region of the cartridge, using hot-end coating, cold-end coating, mouth coating, and/or coating using a plasma. A coating of this kind is conceivable as a preference for a cartridge produced partially or completely from glass. With the aid of such finishing of the glass, an improvement in the sealing properties and adhesion properties is possible, making it possible to achieve a particularly advantageous leaktightness for the cartridge. The sealing element is preferably secured on the cartridge after the application of the coating.

According to one embodiment of the present invention, it is possible for a protective lacquer to be applied to the upper side, facing away from the cartridge, of the sealing element, in particular the crimp cap.

According to one preferred embodiment of the present invention, provision is made for the sealing element to comprise a sealing film. It is possible for the sealing element to be designed completely as a sealing film or for only part of the sealing element to be designed as a sealing film. It would be conceivable, for example, for part of a sealing element designed as a crimp cap to comprise a sealing film.

According to one preferred embodiment of the present invention, provision is made for the sealing film to comprise a plastic film, an aluminum film or a multilayer film of plastic and/or aluminum. Alternatively or in addition, it is conceivable for the sealing film to comprise a foam, a paper and/or other materials. A combination of plastic, and/or aluminum, and/or paper, and/or foam, and/or other materials is also conceivable.

According to one preferred embodiment of the present invention, provision is made for the sealing film to be secured on the flange of the cartridge, in particular in an initial state of the cartridge system, wherein the sealing film is adhesively bonded, sealed and/or welded to the flange of the cartridge. In this case, the sealing film is preferably designed to be at least substantially flat in the state in which it is mounted on the cartridge. In particular, the sealing film is connected to the upper side of the flange (which faces away from the cartridge) and thus, in particular, to the end face of the flange. For this purpose, an encircling peripheral securing region of the sealing element is preferably adhesively bonded, sealed and/or welded to the flange of the cartridge wall. It is advantageously conceivable for the sealing film to be secured on the flange by means of inductive welding. Alternatively or in addition, it is conceivable for the sealing film to be secured on the flange by means of conductive welding. In variants in which the sealing film is connected directly to the flange, the sealing element preferably has no additional sealing body, but rather the opening of the main body of the cartridge is hermetically sealed directly and, in particular, exclusively by the sealing film.

According to one embodiment of the present invention, it is conceivable for the sealing element to have a sealing body, in particular a rigid or semi-rigid sealing body, with a pre-punching, in which a partial region of the sealing body is partially punched. This means that the partial region is not completely punched out of the sealing element but is only partially punched out, and therefore, in the initial state of the cartridge, it remains integrally connected in its corner regions to the rest of the sealing element. Thus, the reservoir remains hermetically sealed in the initial state. The size of the punching corresponds preferably substantially to the through-opening in the sealing element which is to be produced later by the piercing spike. A predetermined breaking point relative to the remaining sealing body is preferably formed in an edge region of the partial region by the partial punching, which breaking point at least partially tears open when the partial region comes into contact with a piercing spike of the cartridge receptacle, in order to expose the through-opening. Owing to the fact that the partial region is punched out of the sealing body, it has substantially the same size or the same diameter as the through-opening, in which the piercing spike is also arranged during beverage making. This advantageously prevents the detached partial region from entering the mixing chamber through the through-opening. The use of a pre-punching in the sealing body is particularly advantageous, for example, when the sealing element is designed as a crimp cap. Depending on the material used and the material thickness of the sealing element, as well as, where applicable, the design of the piercing spike, it is also conceivable according to one embodiment of the present invention to dispense with a pre-punching and a predetermined breaking point. It is conceivable for the sealing body to be produced from one or more metals, in particular from aluminum. It is particularly preferred that the sealing body is mounted on the cartridge with the aid of the flange. In particular, it is conceivable for the sealing body to be crimped, adhesively bonded, sealed and/or welded to the flange of the cartridge. It is particularly preferred that the sealing body is designed as a crimp cap and is crimped on the flange of the cartridge. It is conceivable for the sealing body to have a pre-perforated partial region.

According to one embodiment of the present invention, it is conceivable for the sealing element to have a sealing body, in particular a rigid or semi-rigid sealing body, with a through-opening. It is conceivable for the sealing body to be produced from one or more metals, in particular from aluminum. It is particularly preferred that the sealing body is mounted on the cartridge with the aid of the flange. In particular, it is conceivable for the sealing body to be crimped, adhesively bonded, sealed, welded and/or screwed to the flange of the cartridge. It is particularly advantageously conceivable for the sealing body to be designed as a crimp cap and to be crimped on the flange of the cartridge. In particular, the through-opening is formed either centrally or offset from the center in the sealing body. The sealing body is, in particular, of disk-shaped and/or annular design. Alternatively, it is conceivable for the sealing body likewise to be of cup-shaped design, wherein the encircling part which projects from the cup base is crimped around the flange of the cartridge wall. The part which projects from the cup base is arranged, in particular, on the outer side of the cartridge wall. As a preference, it is conceivable for that part of the sealing body which projects from the cup base and is crimped around the flange to be covered by the cartridge receptacle. In this case, the sealing element is preferably designed as a cup-shaped crimp cap. In its typical wall region, the sealing body preferably has a wall thickness of between 0.09 and 0.5 millimeters, preferably between 0.1 and 0.3 millimeters, particularly preferably between 0.15 and 0.25 millimeters and very particularly preferably substantially 0.2 millimeters, in particular with an error tolerance of at most 15%.

According to one embodiment of the present invention, it is conceivable for the sealing film to close the through-opening of the sealing body in the initial state of the cartridge system. Here, the sealing film is preferably a plastic film, an aluminum film or a multilayer film of plastic and/or aluminum. In this way, despite the through-opening in the sealing body, hermetic sealing of the reservoir is achieved, it being possible for the sealing film to be easily perforated by a piercing spike of the cartridge receptacle during the beverage making process in order to transfer the beverage substance from the reservoir as quickly as possible into the mixing chamber of the cartridge receptacle. According to one embodiment of the present invention, it is conceivable for a circumferential edge of the sealing film to be secured, in particular adhesively bonded, firmly sealed and/or firmly welded, on the sealing body. In this case, the sealing film itself is, in particular, not connected directly to the flange of the cartridge. Alternatively, it is conceivable for the sealing film to be additionally connected to the cartridge, in particular to the flange of the cartridge. It is conceivable, for example, for the sealing film to be additionally secured on the cartridge, in particular the flange, by welding (in particular inductive welding) after crimping, in order to improve the sealing even more. The sealing body can be designed, for example, as a crimp cap and can be crimped onto the flange of the cartridge or can be screwed onto the cartridge as a screw cap. It is conceivable for the sealing body with its bore/punching for the piercing spike to be crimped or screwed onto the cartridge, the bore/punching being closed by a sealing film. The sealing body can have the sealing film on its inner side or outer side. The sealing film can, for example, be applied, sealed or welded to the sealing body. If the sealing film is situated within the cap-shaped sealing body, it is possible for the sealing film—in particular after the crimping or screwing of the sealing body onto the cartridge—to be additionally sealed or welded in both directions or on both sides of the sealing film, in particular with the aid of sealing layers arranged on both sides, in order to prevent water ingress between the sealing body and the sealing film during pasteurization. It is thus conceivable for the sealing film to be preferably preinstalled in the cap-shaped sealing body and—after the sealing body has been crimped or screwed onto the cartridge—to be welded inductively in both directions. For this purpose, it is advantageously possible for the sealing film to have a sealing layer, in particular a sealing lacquer, a laminated or coextruded plastic layer, or the like, on both sides. It is thereby possible in a particularly advantageous manner to prevent moisture from being able to pass between the cap and seal and, in particular, between the sealing body and the sealing film, e.g. after filling and sealing during a pasteurization process.

According to a preferred embodiment of the present invention, provision is made for a seal to be formed between the cartridge and the cartridge receptacle with the aid of a sealing means. It is conceivable, in particular, that the sealing means is arranged partially or completely between an upper side of the sealing element facing away from the cartridge and the cartridge receptacle, such that the sealing means seals the transition between the cartridge receptacle and the cartridge, in particular in the region of its sealing element. In addition or as an alternative to its function as a seal, the sealing means advantageously serves to compensate for manufacturing tolerances of the cartridge, of the sealing element and/or of the cartridge receptacle. According to one preferred embodiment of the present invention, provision is made for the sealing means to be designed as part of the sealing element, and/or for the sealing means to be an element which is separate from the sealing element and is arranged, in particular, between the cartridge and the cartridge receptacle. The sealing means can thus be formed integrally with the sealing element or as a component separate from the sealing element. Various suitable materials, for example various types of rubber and/or plastics or other materials, come into consideration for the sealing means.

According to one preferred embodiment of the present invention, provision is made for the sealing means to have a sealing ring, a full-area sealing means with a bore, and/or a foam. It is conceivable, in particular, for the sealing means to be designed as an O-ring, which is arranged, in particular, partially or completely between the sealing element and the cartridge receptacle. It is alternatively conceivable for the sealing means to be designed with a bore/aperture over the entire area for the piercing spike. Alternatively, it is conceivable for the sealing means to be designed as part of the sealing element and/or connected to the sealing element, in particular on an upper side of the sealing element facing away from the cartridge.

In particular, it is conceivable for the sealing means to comprise a foam (or foamed region) of the sealing element which is arranged on the upper side of the sealing element, in particular in a peripheral outer region of the sealing element. Alternatively or in addition, it is conceivable for the sealing means, e.g. an O-ring and/or foam, to be arranged and/or formed in the region of the connecting means of the cartridge between the cartridge and the cartridge receptacle, in particular between the sealing element of the cartridge and the cartridge receptacle. Alternatively or in addition, the additional sealing between the cartridge and the cartridge receptacle can be accomplished, for example, by embodying the cartridge receptacle with the aid of a two-component plastic.

According to one preferred embodiment of the present invention, provision is made for the sealing means to be designed as an insert, for example as an insertable O-ring, between the cartridge, in particular the end face of the cartridge pointing in the direction of the cartridge receptacle, and the cartridge receptacle. Alternatively or in addition, an embodiment of the sealing means as part of the sealing element is conceivable, in particular with the aid of multicomponent plastic injection molding, preferably two-component plastic injection molding. According to one embodiment of the present invention, it is possible for the sealing means to be formed integrally with the sealing element (as part of the sealing element). In particular, it is possible here for the sealing element and the sealing means to be embodied jointly with the aid of two-component injection molding. In this case, the sealing element particularly preferably comprises a plastic cap. It is preferably possible for the region of the sealing means to be produced from a different plastic than the remaining part of the sealing element. It is conceivable, for example, for the region of the sealing means to be produced from a plastic which is softer than the rest of the sealing element. Thus, it is possible, for example, to produce a comparatively hard sealing element, in particular with the aid of plastic, which at the same time has a less hard region designed as a sealing means. It is conceivable in this context for the sealing means (in particular as a component of the sealing element) to be embodied as a region of the sealing element which points in the direction of the cartridge receptacle, in particular as a region of the sealing element which is adjacent to the cartridge receptacle.

According to one embodiment of the present invention, it is conceivable for the sealing means to be designed as part of the cartridge receptacle, in particular with the aid of multicomponent plastic injection molding, preferably two-component plastic injection molding. It is thus conceivable for the sealing means to be formed integrally with the cartridge receptacle or a part of the cartridge receptacle (that is to say as a component of the cartridge receptacle). In particular, it is possible here for the cartridge receptacle (or at least part of the cartridge receptacle) and the sealing means to be embodied jointly with the aid of two-component injection molding. It is preferably possible for the region of the sealing means to be produced from a different plastic than the remaining part of the cartridge receptacle. It is conceivable, for example, for the region of the sealing means to be produced from a plastic which is softer than the rest of the cartridge receptacle. It is conceivable in this context for the sealing means (in particular as a component of the cartridge receptacle) to be embodied as a region of the cartridge receptacle which points in the direction of the end face of the cartridge wall, in particular as a region of the cartridge receptacle which is adjacent to the end face of the cartridge wall and/or to the sealing element.

According to one preferred embodiment of the present invention, provision is made for the cartridge receptacle to have a basic structure which is produced at least partially and, in particular, completely from plastic. Low-cost production is thereby advantageously achieved.

According to one preferred embodiment of the present invention, provision is made for the basic structure to have a cup-shaped configuration, the open side of which is oriented in the direction of the cartridge, wherein a beverage outlet opening and an outwardly open spike guide are formed on a bottom side, which is situated opposite the cartridge, and wherein a fluid feed is formed on the bottom side or a side wall of the basic structure. This cartridge receptacle has the advantage that the fluid feed opens not into the reservoir of the cartridge but into the mixing chamber, which is separated from the reservoir. This prevents the beverage preparation machine from being back-contaminated by the fluid feed during the beverage making process. For this purpose, the fluid does not flow through the reservoir, but rather the beverage substance and the fluid pass separately from one another into the mixing chamber of the cartridge receptacle. The fluid is passed directly into the mixing chamber, while the beverage substance is transferred into the mixing chamber independently of the fluid. For this purpose, in particular, a displaceably mounted piercing spike is arranged within the spike guide, wherein the piercing spike is displaceable between a retracted position, in which the piercing spike is away from the sealing element and, in particular, from the sealing film (or the partial region), and an extended position, in which the piercing spike pierces the sealing element and, in particular, the sealing film (or partially or completely tears off the partial region from the sealing element) and projects into the reservoir. In the initial state of the cartridge system, therefore, the piercing spike is in the retracted position, with the result that the reservoir is hermetically sealed by the sealing element and, in particular, the sealing film, and can be transferred from the retracted position into the extended position in order to open the sealing element of the cartridge. In the extended position, the sealing element is perforated by the piercing spike or a pre-punching is torn open such that the beverage substance passes past the sealing element and into the mixing chamber through, in particular, at least one lateral channel on the piercing spike. Thus, easy and reliable opening of a cartridge, previously closed in an aroma-tight manner, in a beverage preparation machine is allowed. It has also been found that back-contamination of the beverage preparation machine is prevented, in particular since no overpressure acting directly on the fluid feed is generated in the reservoir. The formation of the mixing chamber in the cartridge receptacle, which is reversibly insertable into the beverage preparation machine, advantageously ensures that the mixing chamber is part of the exchangeable cartridge system. In this way, soiling of the beverage preparation machine by the beverage substance is effectively avoided because only parts of the exchangeable disposable or reusable cartridge system come into contact with the beverage substance.

According to one preferred embodiment of the present invention, provision is made for the outer wall of the piercing spike to have at least one lateral channel for conveying the beverage substance in the direction of the mixing chamber when the sealing element has been pierced.

According to one preferred embodiment of the present invention, provision is made for the cartridge system and, in particular, the cartridge receptacle to have at least one supporting structure, which supports the sealing film in the direction of the cartridge receptacle and, in particular, in the direction of the mixing cartridge. In this way, tearing of the sealing film is prevented, particularly when pressure builds up in the reservoir during the beverage making process. The supporting structure comprises, in particular, a pillar-shaped, bridge-shaped, lattice-shaped or cylindrical structure which projects from the bottom of the mixing chamber in the direction of the reservoir and on which the sealing film partially rests.

According to one preferred embodiment of the present invention, provision is made for the piercing spike to comprise a cylindrical or frustoconical base part and a piercing part that extends in the direction of the reservoir, wherein the piercing part is configured in the form of an obliquely truncated cone. Preferably, the piercing part is also configured such that an oblique cut face of the obliquely truncated cone substantially faces the reservoir, wherein the oval circumference of the cut face at least partially represents a cutting edge for perforating the sealing element. It has been found that the cut face which is produced by an oblique cut through the truncated cone cuts the sealing element easily and with sufficiently little force, and, moreover, does not cut off any shavings or loose bits from the sealing element, which would otherwise contaminate the beverage in an undesired manner. The sealing-element perforation is advantageously of such a form that the material of the sealing element is cut through with a smooth cut on that side of the piercing spike on which the cutting edge protruding maximally in the direction of the reservoir is formed, while, in the region of the cut face of the piercing part, the cut-off material of the sealing element is still connected to the rest of the sealing element and preferably rolls up or is folded together.

Preferably, the piercing spike comprises an intermediate part arranged between the base part and the piercing part, said intermediate part being configured in a frustoconical manner, wherein a circumferential shoulder is formed between the base part and the intermediate part, and wherein a circumferential edge is formed between the piercing part and the intermediate part. In this way, a stable piercing spike is advantageously formed. The formation of the edge has the advantage that, provided that they extend over the edge, the lateral channels have an enlarged entry on the reservoir side and thus the transfer of the beverage substance in the direction of the mixing chamber is made easier. The shoulder serves to butt against a stop of the spike guide when the piercing spike is in the extended position, such that the extending movement of the piercing spike in the direction of the cartridge is limited.

According to one preferred embodiment of the present invention, provision is made for the cartridge receptacle to have a plurality of lateral channels, wherein each lateral channel extends parallel to the piercing spike in the region of the piercing part and in the region of the intermediate part. The lateral channels are in this case each configured in particular in the form of a groove, open on one side, introduced into the outer face of the piercing spike. Preferably, the lateral channels are formed at least partially in a rear circumferential region, with respect to the cut face, of the piercing spike. This has the advantage that the lateral channels are arranged on that side of the sealing-element perforation on which a cut has been created in the material, and not on the opposite side, on which the cut-off material is still connected to the rest of the sealing element. The beverage substance can thus flow into the lateral channels in a comparatively unimpeded manner.

It is conceivable for the cross section of the lateral channels and/or the number of the lateral channels to be adapted to the viscosity of the beverage substance, such that the lateral channels control or limit the flow of the beverage substance in the direction of the mixing chamber. At a high viscosity, a plurality of lateral channels or lateral channels with a relatively large cross section are used, while, at a lower viscosity, fewer lateral channels or lateral channels with a smaller cross section are provided. Thus, a matching cartridge receptacle exists for each cartridge.

According to one preferred embodiment of the present invention, provision is made for the piercing spike to have a twist prevention means in the form of a rib protruding radially from the base part. Twisting of the piercing spike is thus advantageously avoided while it is being transferred from the retracted position into the extended position. It is also ensured that the lateral channels are arranged on that side of the piercing spike which faces away from the beverage outlet of the mixing chamber and in particular faces the fluid feed. In this way, improved mixing of the beverage substance and the fluid within the mixing chamber is achieved.

According to one preferred embodiment of the present invention, provision is made for the piercing spike to have an integrated compressed-air line, which is the cartridge emptying device, wherein the compressed-air line extends along the piercing spike, in particular from a first end of the piercing spike to a second end of the piercing spike. In this way, three functions are advantageously integrated into the piercing spike: 1. The piercing spike comprises the piercing part in order to perforate the sealing element and thus to open the cartridge; 2.

The piercing spike comprises the lateral channels in order to allow the beverage substance to be transferred into the mixing chamber; 3. The piercing spike comprises the integrated compressed-air line in order to blow compressed air into the reservoir, with the result that the beverage substance is pushed into the mixing chamber under pressure.

Preferably, a compressed-air connection for connecting to a compressed-air source is formed at the second end, and a compressed-air outlet for blowing compressed air into the reservoir is formed at the first end. The cartridge emptying device integrated into the cartridge receptacle thus comprises, within the meaning of the present invention, first of all only one compressed-air line, through which compressed air can be introduced into the reservoir from the outside. The cartridge receptacle is configured such that the beverage substance is pushed out of the reservoir into the mixing chamber by the compressed air. The compressed air is provided in particular by the beverage preparation machine. It is conceivable for a compressed-air source to be coupled directly to the compressed-air connection as soon as the cartridge system is inserted into the beverage preparation machine. This has the advantage that back-contamination in the direction of the beverage preparation machine is effectively avoided because the cartridge emptying device is, in particular immediately, under pressure when the cartridge system is inserted and thus beverage substance is prevented from traveling in the direction of the compressed-air line and in particular in the direction of the compressed-air source of the beverage preparation machine. The beverage substance can thus move only in the direction of the mixing chamber from the reservoir.

According to one preferred embodiment of the present invention, provision is made for the compressed-air outlet to be configured as an opening in the cut face. This has the advantage that the air flowing into the reservoir is blown in on a side of the piercing spike that is remote from the lateral channels, such that the discharging of the beverage substance into the mixing chamber is not impeded. Preferably, a swirl thus forms in the reservoir, this favoring virtually residue-free emptying of the reservoir.

The compressed-air connection is configured in particular as an opening in the base part, wherein the base part is arranged in the cartridge receptacle such that the compressed-air connection is accessible from outside the cartridge receptacle. In this way, the connection of the compressed-air line to the compressed-air source is favored.

According to one preferred embodiment of the present invention, provision is made for the spike guide to have a guide part with an internal guide channel for receiving the piercing spike, wherein the guide channel of the guide part is configured in a substantially cylindrical or frustoconical manner, and wherein a circumferential stop is formed at an end of the guide part that faces the cartridge, said stop limiting the movement of the piercing spike in the direction of the reservoir, wherein the stop comprises in particular a region with a reduced diameter. In this way, reliable guiding of the piercing spike during the movement from the retracted position into the extended position is advantageously achieved. Preferably, a groove corresponding to the rib is formed as twist prevention means within the wall of the guide channel, such that undesired twisting of the piercing spike is prevented. The guide part is preferably arranged in the mixing chamber and protrudes from a bottom of the mixing chamber in the direction of the cartridge.

According to one preferred embodiment of the present invention, provision is made for the piercing spike to be configured as a plastic part and in particular as an injection-molded plastic part. This allows cost-effective production. In principle, however, it would also be conceivable as an alternative for the piercing spike to be formed as a metal part and/or from ceramics and/or other suitable materials.

According to one preferred embodiment of the present invention, provision is made for the piercing spike to be configured such that it is transferable from the retracted position into the extended position by a release element of the beverage preparation machine when the cartridge system is inserted into the beverage preparation machine.

According to a further preferred embodiment of the present invention, provision is made for the mixing chamber to have a beverage outlet through which the beverage formed from a blend of the beverage substance with the fluid is discharged, wherein the cartridge system is preferably configured such that the beverage is able to be introduced directly into a portable vessel from the beverage outlet. Advantageously, therefore, neither the beverage substance nor the produced beverage comes into contact with any part of the beverage preparation machine, and so any (back-)contamination of the beverage preparation machine is more or less avoided. The fluid is fed to the mixing chamber separately. Preferably, the fluid is introduced into the mixing chamber under pressure. The fluid is provided in particular by the beverage preparation machine. It is conceivable for a fluid source to be coupled directly to a corresponding fluid connection of the cartridge receptacle as soon as the cartridge system is inserted into the beverage preparation machine. The fluid connection is in this case fluidically connected to the mixing chamber via a fluid line. This has the advantage that back-contamination in the direction of the beverage preparation machine is effectively avoided because the fluid connection is, in particular immediately, under pressure when the cartridge system is inserted and thus beverage substance is prevented from traveling in the direction of the fluid line and in particular in the direction of the fluid source of the beverage preparation machine. The beverage substance and the beverage can thus move only in the direction of the beverage outlet from the mixing chamber. The fluid comprises in particular water, preferably pressurized, cooled and/or carbonated drinking water.

According to one preferred embodiment of the present invention, provision is made for the mixing chamber to be provided with mixing structures. The mixing structures advantageously ensure improved mixing of beverage substance and fluid. For this purpose, the mixing structures are configured in particular such that the fluid flowing into the mixing chamber is swirled. It is conceivable for the mixing structure to comprise one or more mixing ribs which are arranged in the region of the fluid feed at the bottom of the mixing chamber and extend substantially perpendicular to the direction in which the fluid flows in. The mixing ribs thus act as barriers for the fluid, with the result that the fluid is swirled up and better mixing with the beverage substance is achieved.

According to a further preferred embodiment of the present invention, provision is made for the fluid feed to be supplied with fluid which is cooled by a refrigeration unit, wherein the refrigeration unit is part of the beverage preparation machine or of a separate refrigerator operatively connected to the beverage preparation machine. Advantageously, it is thus possible for cold beverages to be produced even when the cartridge is not cooled and is at room temperature for example. The integration of the system into an existing refrigerator has the advantage that the existing refrigeration unit of the refrigerator can be co-used easily in an efficient manner for the beverage preparation machine. In particular, in what are known as “side-by-side” refrigerators (often also referred to as American refrigerators), sufficient installation space for integrating the system is found in the front. It is conceivable for the beverage preparation machine to be a retrofitting set for such a refrigerator. The refrigeration unit comprises preferably a compressor cooling unit, an absorber cooling unit or a thermoelectric cooler.

According to a further preferred embodiment of the present invention, provision is made for the fluid feed to be supplied with fluid to which carbonic acid is added by a carbonator. It is conceivable for the carbonator to be part of the beverage preparation machine, and wherein the carbonator has a receptacle for a CO₂ cartridge and a feeding device for adding CO₂ from the CO₂ cartridge to the fluid. Advantageously, it is thus also possible to produce carbonated soft drinks with the system. Alternatively, it would also be conceivable for the carbonator to have an external CO₂ connection.

The present invention furthermore relates to a beverage preparation machine comprising a cartridge system according to one embodiment of the present invention. The cartridge system can be inserted into the beverage preparation machine. In the inserted state of the cartridge system in the beverage preparation machine, the beverage can be prepared. After preparation has taken place, the cartridge system can be removed again from the beverage preparation machine.

The present invention furthermore relates to a process for manufacturing a cartridge system according to one embodiment of the present invention, wherein, in a first process step, the cartridge wall of the cartridge, comprising the flange, is formed, wherein, in a second process step, a sealing element is secured on the cartridge with the aid of the flange, wherein, in a third process step, the cartridge is connected to the cartridge receptacle.

It is preferably possible for the flange to be formed integrally with the rest of the cartridge wall. For example, both can be produced from glass and, in particular, can be part of a glass cartridge. Alternatively, it is also conceivable for the flange to be an element which is separate from the rest of the cartridge wall and is connected, in particular leaktightly, to the rest of the cartridge wall in the first step.

According to one embodiment of the present invention, in particular of the process, provision is made, in an intermediate step carried out before the third process step, for the cartridge receptacle to be produced by injection molding of plastic. Advantageously, therefore, that part of the cartridge system which does not undergo high pressurization by introduction of compressed air is produced in plastic by a low-cost manufacturing process, thereby making it possible to keep the overall production costs low.

According to one embodiment of the present invention, in particular of the process, provision is made for a piercing spike to be produced in a further intermediate step, which is carried out before or after the third process step, and to be introduced into a spike guide of the cartridge receptacle.

According to one embodiment of the present invention, in particular of the process, provision is made, in a further intermediate step carried out before the second process step, for the sealing element and/or the sealing body of the sealing element to be punched out and/or cut out from a metal sheet, in particular an aluminum sheet, and/or from a sealing film, preferably a plastic film, an aluminum film or a multilayer film of plastic and/or aluminum. If an aluminum sheet is used, in particular the sheet is then deep-drawn before or during the second process step in such a way that the sealing body, formed from the aluminum sheet, of the sealing element or the entire sealing element preferably has in its typical wall region a wall thickness of between 0.09 and 0.5 millimeters, preferably between 0.1 and 0.3 millimeters, particularly preferably between 0.15 and 0.25 millimeters and very particularly preferably substantially 0.2 millimeters, in particular with a error tolerance of at most 15%. It is also conceivable for a thicker wall thickness, in particular of more than 0.5 millimeters, to be used. It is conceivable, for example, for the wall thickness to be thicker than 0.5 mm in a region of the sealing element which is not intended for piercing by the piercing spike, the sealing element having a pre-punching/weakening for the piercing spike.

According to one embodiment of the present invention, in particular of the process, it is conceivable, in the further intermediate step, for the partial region in the sealing body to be partially punched in order to form the pre-punching. The pre-punching thus defines the later through-opening which, in the initial state, is closed by the partial region still attached to the remaining sealing body and is only opened by the piercing spike immediately before or during beverage making.

According to one embodiment of the present invention, in particular of the process, provision is made for the sealing element to be formed around the flange of the cartridge wall before or during the second process step. This forming can be carried out both in the variant in which the sealing element comprises the sealing body, in particular a crimp cap, produced from a rigid or semi-rigid aluminum, and in the variant in which the sealing element consists exclusively of the sealing film.

According to one preferred embodiment of the present invention, in particular of the process, provision is made, during the second process step, for the sealing element to be crimped and/or screwed to the flange. Particularly advantageous attachment of the sealing element to the cartridge, which can also withstand high internal pressures in the cartridge, can thereby be achieved. Particularly if the sealing element comprises a sealing body made of a rigid or semi-rigid aluminum, the sealing body is preferably crimped to the flange of the cartridge wall.

According to one embodiment of the present invention, in particular of the process, provision is made, during the second process step, for the sealing element to be adhesively bonded, sealed and/or welded to the flange. In this case, the sealing element is preferably designed as a sealing film. Adhesive bonding, sealing and/or welding are particularly preferred if the sealing element consists exclusively of a sealing film.

According to one embodiment of the present invention, in particular of the process, it is alternatively or additionally conceivable for a through-opening to be produced in the sealing element in a further intermediate step, in particular for it to be drilled, punched or lasered into the sealing element, wherein the through-opening is closed with a sealing film in a subsequent further intermediate step, wherein the sealing film is preferably adhesively bonded, welded and/or sealed onto the sealing element. This embodiment relates to the variant in which the sealing element comprises the sealing body made of a rigid or semi-rigid aluminum. This sealing body is provided with the through-opening, which is closed by the perforatable sealing film in the subsequent intermediate step. This sealing film can be arranged and secured on the sealing body on the same side as the mixing chamber or can be arranged and secured on the sealing body on the same side as the reservoir. The through-opening can be produced during the formation of the sealing element.

According to one embodiment of the present invention, in particular of the process, it is alternatively or additionally conceivable for a connecting means, in particular a latching groove, a latching bead, an undercut or an external thread, to be formed in the cartridge wall during or after the first process step. According to one embodiment of the present invention, in particular of the process, it is furthermore conceivable that, before the third process step and in particular during the injection molding of the cartridge receptacle, a mating connecting means, in particular a latching groove, a latching bead, an undercut or an internal thread, is produced on the cartridge receptacle. Alternatively or in addition, it is conceivable for a wall of the cartridge receptacle to be crimped around the cartridge.

According to one embodiment of the present invention, in particular of the process, provision is made for a seal to be formed between the cartridge and the cartridge receptacle before, during and/or after the third process step with the aid of a sealing means.

According to one embodiment of the present invention, in particular of the process, provision is made for the sealing means to be formed and/or arranged on an upper side of the sealing element facing away from the cartridge before the third process step and/or during the third process step, in particular before, during and/or after the second process step.

It is conceivable for the sealing means to be designed as part of the sealing element and/or to be connected to the sealing element, in particular before, during and/or after the second process step. As a preferred possibility, the sealing means comprises a foam with which a foamed region of the sealing element is formed on its upper side which faces away from the cartridge. With the aid of the sealing means, improved sealing between the cartridge and the cartridge receptacle can be formed in or after the third process step. For this purpose, the sealing means preferably interacts with a region of the cartridge receptacle in the third process step.

Alternatively or in addition, it is conceivable for a sealing means to be arranged between the cartridge and the cartridge receptacle, in particular between the upper side of the sealing element, which faces away from the cartridge, and the cartridge receptacle, before and/or during the third process step, preferably after the second process step. In this case, the sealing means is preferably an element which is separate from the sealing element and is arranged, in particular, between the sealing element and the cartridge receptacle. As a preference, it is possible for the sealing means to comprise a sealing ring, in particular an O-ring, which is arranged between the cartridge and the cartridge receptacle, in particular between the upper side of the sealing element, which faces away from the cartridge, and the cartridge receptacle, before and/or during the third process step. With the aid of the sealing means, improved sealing between the cartridge and the cartridge receptacle can be formed in or after the third process step. For this purpose, the sealing means preferably interacts with a region of the cartridge receptacle in the third process step.

According to one preferred embodiment of the present invention, in particular of the process, it is alternatively or additionally conceivable for the sealing means, for example an O-ring and/or foam, to be arranged between the cartridge and the cartridge receptacle in the region of the connecting means of the cartridge. It is possible for the sealing means to be arranged between the sealing element of the cartridge and the cartridge receptacle in the region of the connecting means of the cartridge.

In the first process step, the cartridge or at least the main body of the cartridge, which is in particular in the form of a cup, is preferably produced from glass. Alternatively, however, it is also conceivable for the cartridge to be produced from plastic and/or a metal, in particular aluminum. In the variant in which the main body or the cartridge is produced from aluminum, it is conceivable for the main body or the cartridge to be produced by deep drawing or extrusion. The main body is preferably of cup-shaped design with a cylindrical cartridge wall which is closed on one side by a cartridge base, the cartridge wall and the cartridge base being, in particular, of integral design. It is conceivable for the cartridge wall and the cartridge base to consist of one piece and preferably both of glass. Alternatively, it is also conceivable for the cartridge to be produced from a plurality of individual parts. It is conceivable, for example, for the cartridge wall and the cartridge base to be separate parts which are connected to one another, in particular leaktightly, for example in the first process step.

For the process according to the invention for manufacturing a cartridge system and the beverage preparation machine according to the invention, it is possible to make use of the advantages and embodiments which have already been described in connection with the cartridge system according to the invention or in connection with an embodiment of the cartridge system according to the invention. For the cartridge system according to the invention and the process according to the invention for manufacturing a cartridge system, it is possible to make use of the advantages and embodiments which have already been described in connection with the beverage preparation machine according to the invention or in connection with an embodiment of the beverage preparation machine according to the invention. For the cartridge system according to the invention and the beverage preparation machine according to the invention, it is possible to make use of the advantages and embodiments which have already been described in connection with the process according to the invention for manufacturing a cartridge system or in connection with an embodiment of the process according to the invention for manufacturing a cartridge system.

Further details, features and advantages of the invention are apparent from the drawings, and from the following description of preferred embodiments with reference to the drawings. The drawings illustrate merely exemplary embodiments of the invention which do not limit the essential concept of the invention.

### BRIEF DESCRIPTION OF THE DRAWINGS

FIG. 1 shows a schematic side view of a cartridge of a cartridge system according to one illustrative embodiment of the present invention.

FIG. 2 shows a schematic sectional view of the cartridge along the section plane B-B shown in FIG. 1.

FIG. 3a shows a schematic detail view of the mouth region of the cartridge along the section plane B-B shown in FIG. 1.

FIG. 3b shows a schematic detail view of the mouth region of the cartridge according to one illustrative embodiment of the present invention.

FIG. 4 shows a schematic perspective view of a cartridge sectioned along the section plane B-B shown in FIG. 1.

FIG. 5 shows a schematic perspective view of a sectioned cartridge of a cartridge system according to one illustrative embodiment of the present invention.

FIGS. 6a and 6b show schematic perspective views of a sectioned cartridge for a cartridge system according to one illustrative embodiment of the present invention.

FIG. 7 shows a schematic perspective view of a sectioned cartridge for a cartridge system according to one illustrative embodiment of the present invention.

FIG. 8 shows a schematic perspective view of a sectioned cartridge of a cartridge system according to a further illustrative embodiment of the present invention.

FIGS. 9a, 9b, and 9c show a perspective illustration, a schematic sectional view, and the general operating principle of a cartridge system according to an illustrative first embodiment of the present invention.

FIGS. 10a, 10b and 10c show schematic views of a cartridge system according to an illustrative second embodiment of the present invention.

FIG. 11 shows a schematic perspective view of a sectioned sealing element according to one illustrative embodiment of the present invention.

### EMBODIMENTS OF THE INVENTION

In the various figures, identical parts are always provided with the same reference signs and are therefore each generally also mentioned only once.

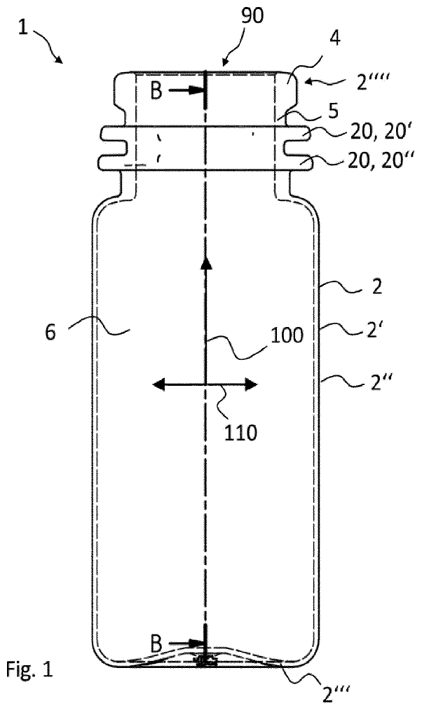

FIG. 1 illustrates a schematic side view of a cartridge 2 for a cartridge system 1 according to one illustrative embodiment of the present invention. The cartridge 2 comprises a cup-shaped hollow main body 2′, with the aid of which a reservoir 6 for a beverage substance 7 is formed. Here, “of cup-shaped design” means that the main body 2′ has a cartridge base 2′″ (illustrated at the bottom in the drawing) and a cartridge wall 2″ projecting at a right angle (in particular in the direction of the cartridge receptacle 10, not illustrated) from the cartridge base 2′″. In this case, the cartridge wall 2″ is of at least partially cylindrical and encircling design, while the cartridge base 2′″ in this example has a circular configuration. The main body 2′ of the cartridge 2 or the cartridge 2 itself is preferably formed by or at least with the aid of a glass bottle. The reservoir 6 of the cartridge 2 can be filled with a beverage substance 7. FIG. 1 furthermore illustrates a central axis of extent 100 of the cartridge 2, which represents an axial direction of the cartridge 2, and a radial axis 110, which is perpendicular to the central axis of extent 100 and represents a radial direction.

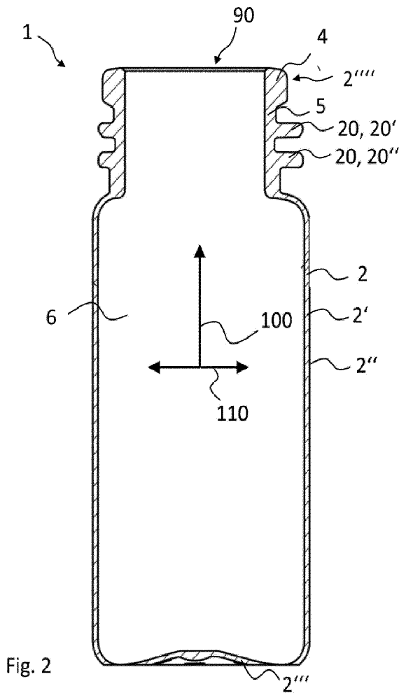

On a side opposite the cartridge base 2′″ in the axial direction, the cartridge 2 has an opening 90, which can be closed by a sealing element 18. In order to attach and secure the sealing element 18, the cartridge 2 has a flange 4, which is designed as a widened mouth region of the cartridge wall 2″ at an edge 2″″ of the cartridge wall 2″. The opening 90 of the cartridge 2 is thus surrounded by the flange 4. Furthermore, the cartridge 2 comprises a connecting means 20, which is formed by a latching bead 20′ and a further latching bead 20″. The connecting means 20 is designed for connecting the cartridge 2 to a cartridge receptacle 10. Furthermore, the radial extent of the latching beads 20′, 20″ is not constant around the circumference of the cartridge 2. In particular, the radial extent of the latching beads 20′, 20″ on one side of the cartridge is greater than on the opposite side (see FIG. 2). Alternatively, it is conceivable for the flange 4 to have the connecting means 20, for example an external thread.

FIG. 2 illustrates a schematic sectional view of the cartridge 2 illustrated in FIG. 1 along the section plane B-B shown in FIG. 1. The radial extent of the latching beads 20′, 20″ is not constant around the circumference of the cartridge 2. In particular, the radial extent of the latching beads 20′, 20″ on one side of the cartridge (right-hand side in FIG. 2) is greater than on the opposite side (left-hand side in FIG. 2). Thus, a flattened portion is formed in one region of the connecting means 20. As a result, a twist prevention means for the cartridge 2 is implemented in the cartridge receptacle 10, and therefore, when the cartridge 2 is connected to the cartridge receptacle 10, a fixed relative orientation is advantageously formed between the cartridge 2 and the cartridge receptacle 10. For this purpose, the cartridge receptacle 10 has corresponding mating connecting means with a flattened portion, in particular latching grooves with depths which vary around the circumference of the latching grooves (not illustrated). Since the flange 4 is a region which is separate from the connecting means 20, despite this flattening of the latching means (or of the connecting means 20), it is nevertheless advantageously possible to use a circular crimp cap 180 as a sealing element 18, which is crimped around the flange 4, which is, in particular, circular.

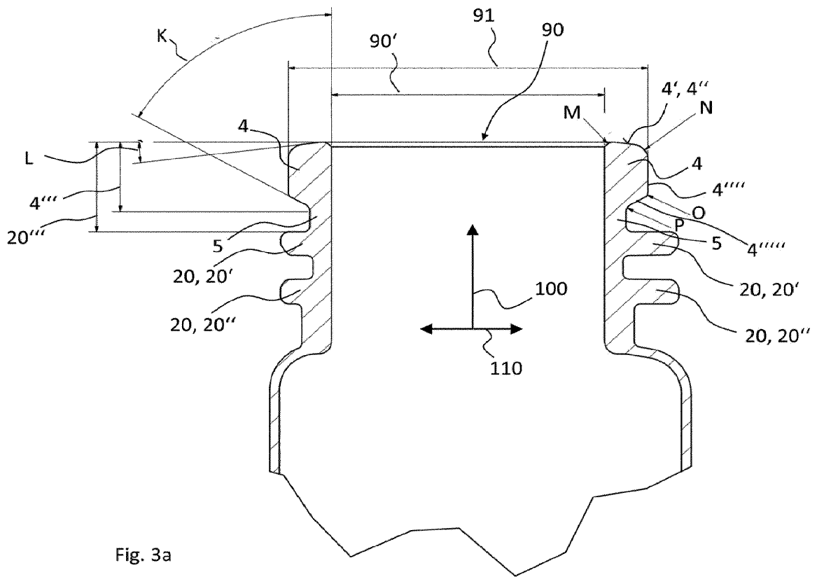

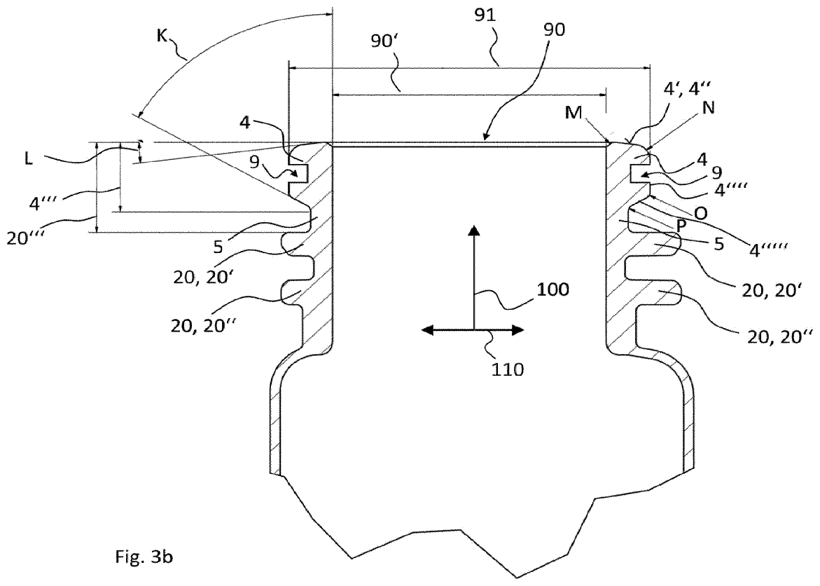

FIG. 3a illustrates a schematic sectional view of the cartridge 2 shown in FIG. 1 along the section plane B-B shown in FIG. 1, only the upper region of the cartridge 2 being illustrated in an enlarged detail view. The flange 4 forms the end of the cartridge 2 opposite the cartridge base 2′″ in the axial direction and is formed around the opening 90 of the cartridge 2. The opening 90 is preferably of circular design and preferably has a diameter 90′ of at least 18 mm. In the embodiment illustrated, the diameter 90′ of the opening is 22 mm (with, in particular, a manufacturing tolerance of at most 15%). Other values for the diameter 90′ are also conceivable.

The outer diameter 91 of the flange 4 (from outer side 4″″ to outer side 4″″ of the flange 4) is preferably at most 29 mm (with, in particular, a manufacturing tolerance of at most 15%). However, other values for the outer diameter 91 are also conceivable.

An end face 4″ of the flange 4 is formed on the upper side 4′ of the flange 4, which faces away from the cartridge base 2′″. At its radially inner end, the end face 4″ merges, by way of a first radius of curvature M, into an inner side of the cartridge 2. The first radius of curvature M particularly advantageously prevents the sealing element 18 from being able to tear open unintentionally in this region. In the illustrated embodiment, the first radius of curvature M is 0.6 mm (with, in particular, a manufacturing tolerance of at most 15%). However, other values for the first radius of curvature M may also be considered.

The end face 4″ or the upper side 4′ of the flange 4 is not arranged parallel to the radial axis 110 but falls in the radial direction from the inside to the outside (that is to say with increasing distance from the central axis of extent 100) in the direction of the cartridge base 2′″. Thus, the end face 4″ has an upper opening angle L with respect to the radial axis 110. In the embodiment shown, the opening angle L=7°. However, other values for the opening angle L are also conceivable. In particular, the end face 4″ can also be formed perpendicularly to the central axis of extent 100 of the cartridge, that is to say can run parallel to the radial axis 110. A parallel course of the end face 4″ to the radial axis 110 (that is to say, in particular, with an opening angle L=0°) is particularly advantageous if the sealing element 18 is designed as a sealing film 18″ and is secured on the end face 4″ of the flange 4, for example by inductive welding.

In its radially outer end, the upper side 4′ or the end face 4″ of the flange 4 merges with a second radius of curvature N into an outer side 4″″ of the flange 4, wherein the outer side 4″″ extends circumferentially around the cartridge 2. The outer side 4″″ of the flange 4 extends, in particular, parallel to the central axis of extent 100. Crimping of a sealing element 18 around the flange 4 can be improved in a particularly advantageous manner by means of the second radius of curvature N since no sharp edge is present. In the illustrated embodiment, the second radius of curvature N has a radius of 1.3 mm (with, in particular, a manufacturing tolerance of at most 15%). However, other values for the second radius of curvature N may also be considered as alternatives. In its lower end, the outer side 4″″ of the flange 4 merges with a third radius of curvature O into a lower side 4″″ of the flange 4. It is possible for the crimping of a sealing element 18 around the flange 4 to be improved in a particularly advantageous manner by the third radius of curvature O. In the illustrated embodiment, the third radius of curvature O has a radius of 0.5 mm (with, in particular, a manufacturing tolerance of at most 15%). However, other values for the third radius of curvature O may also be considered as alternatives.

The lower side 4″″ of the flange 4 has a lower opening angle K of 60° with respect to the central axis of extent 100 (and thus an angle of 30° with respect to the radial axis 110). Other values for the lower opening angle K of 60° may also be considered as alternatives.

A secondary region 5 of the cartridge wall 2″ is formed adjacent to the lower side 4″″ of the flange 4. A fourth radius of curvature P is formed as a transition between the lower side 4″″ of the flange 4 and the secondary region 5. In the illustrated embodiment, the fourth radius of curvature P has a radius of 0.7 mm (with, in particular, a manufacturing tolerance of at most 15%). However, other values for the fourth radius of curvature P may also be considered as alternatives.

In the illustrated embodiment, the height 4′″ of the flange 4, including the region formed by the fourth radius of curvature P, is 6.1 mm (with, in particular, a manufacturing tolerance of at most 15%). However, other values for the height 4′″ may also be considered. By virtue of its height 4′″, the flange 4 can be used particularly advantageously to secure a sealing element 18, which is crimped around the flange 4, on the cartridge 2.

The connecting means 20 of the cartridge 2, by means of which a connection to the cartridge receptacle 10 can be produced, is designed to be offset from the flange 4 in the axial direction (that is to say parallel to the central axis of extent 100) in the direction of the cartridge base 2″. The connecting means 20 and the flange 4 are thus separate elements and, in particular, elements that are spaced apart from one another. The secondary region 5 of the cartridge wall 2″ is arranged between the connecting means 20 and the flange 4 in the axial direction. At its upper end, the secondary region 5 is adjacent to the flange 4 and, at its lower end, is adjacent to the latching bead 20′, with the result that a groove is formed between the flange 4 and the connecting means 20 by the secondary region 5. Here, the wall thickness of the cartridge wall 2″ is less in the secondary region 5 than in the region of the flange 4, so that the flange 4 protrudes in the radial direction starting from the secondary region 5. The spacing 20′″ of the connecting element 20, in particular of the latching bead 20′, from the upper edge, formed by the end face 4″, of the flange 4 is 7.9 mm (with, in particular, a manufacturing tolerance of at most 15%).

FIG. 3b illustrates a schematic sectional view of a cartridge 2 according to one embodiment of the present invention. The embodiment illustrated in FIG. 3b is similar to the embodiment shown in FIG. 3a, with the difference that the flange 4 has an encircling indentation 9 on its outer side In particular, the indentation 9 is designed as a radial thinning of the flange 4. The flange 4, which is designed as a thickened region of the cartridge wall 2″, is thus locally thinned. Such thinning is advantageous particularly if the cartridge 2 or the cartridge wall 2″ is produced from plastic. It is particularly advantageously conceivable for the two rings of the flange 4 which are formed by the indentation 9 of the flange 4 (above and below the indentation 9) to be reinforced by one or more vertical webs in order to be able to advantageously absorb crimping forces.

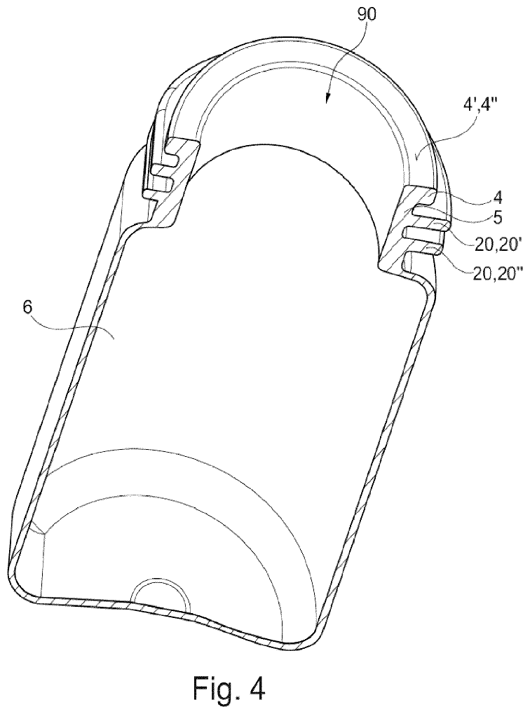

FIG. 4 shows a schematic perspective view of a cartridge 2 according to the exemplary embodiment illustrated in FIGS. 1 to 3a cut along section plane B-B.

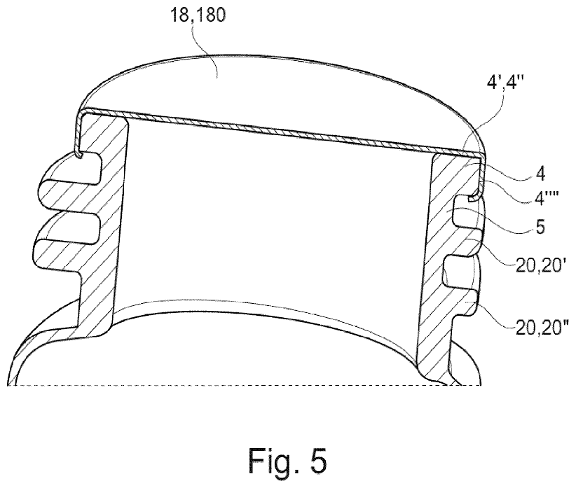

FIG. 5 shows a schematic perspective sectional view of a cartridge 2 for a cartridge system 1 according to one illustrative embodiment of the present invention. In this case, the opening 90 of the cartridge 2 is closed by a sealing element 18 designed as a crimp cap 180. The crimp cap 180 is crimped around the flange 4 of the cartridge 2 and thereby secured on the cartridge 4. In this case, the sealing element 18 surrounds both the upper side 4′ of the flange 4 and the outer side 4″″ of the flange and is formed around the regions of the flange 4 with the radii of curvature N and O. The sealing element 18 ends in the region of the lower side 4″″ of the flange 4. Particularly advantageous closure of the cartridge 2 can thereby be achieved. The crimped sealing element 18 withstands even high internal pressures, which can be formed inside the cartridge 2, in particular in the reservoir 6. It is thus possible to enclose a beverage substance 7 under high pressure in the reservoir 6 and thus to accomplish pre-carbonation, which is advantageous for many beverage substances. The crimp cap 180 is preferably produced from a metal, in particular from aluminum. A coating, in particular a sealing layer, such as, for example, a lacquer and/or a laminated or coextruded plastic, is/are arranged on the lower side of the crimp cap 180, that is to say the side of the crimp cap 180 which faces in the direction of the cartridge 2. In particular, the sealing layer is arranged between the flange 4 and the crimp cap 180. With the aid of the sealing layer, advantageous sealing is possible. It is optionally possible in addition or as an alternative for a seal to be arranged between the crimp cap 180 and the flange 4. It is conceivable, for example, for the seal to be of annular design or of full-area design (that is to say continuous, in particular in the form of a disk). The seal can be introduced into the crimp cap 180, in particular sealed, adhesively bonded and/or foamed. With the aid of the seal, additionally improved sealing is possible. It is furthermore conceivable for a protective lacquer to be applied to the upper side of the crimp cap 180, the side which faces away from the cartridge 2.

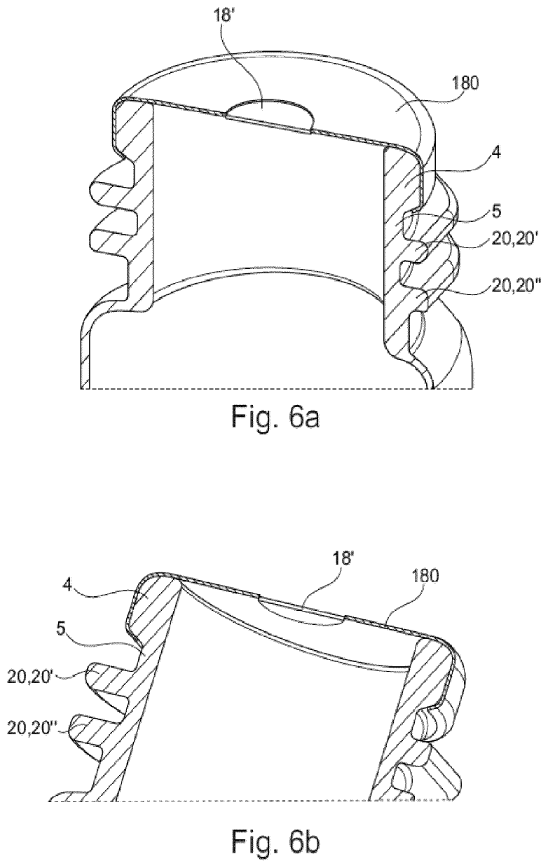

FIGS. 6a and 6b show schematic perspective sectional views of a cartridge 2 for a cartridge system 1 according to one illustrative embodiment of the present invention. As in the exemplary embodiment illustrated in FIG. 5, the sealing element 18 or a sealing body of the sealing element 18 is designed as a crimp cap 180. The sealing element 18, that is to say the crimp cap 180, comprises a pre-stamping or pre-punching 18′ which is formed centrally on the crimp cap 180. Alternatively, it is also conceivable for the pre-punching 18′ to be designed to be offset from the center of the sealing element 18. By means of the pre-punching 18′, in particular by means of the edge of the pre-punching 18′, a predetermined breaking point of the sealing element 18 is advantageously formed, which breaking point is torn open when the sealing element 18 comes into contact with a piercing spike 73. An advantageously defined opening can thus be produced in the sealing element 18. It is conceivable preferably for a sealing layer, in particular a lacquer and/or a laminated or coextruded plastic, preferably comprising polypropylene and/or some other plastic, to be arranged on the lower side of the crimp cap 180, that is to say the side of the crimp cap 180 which faces in the direction of the cartridge 2. In particular, the sealing layer is arranged between the flange 4 and the crimp cap 180. With the aid of the sealing layer, advantageous sealing is possible. The pre-stamping or pre-punching 18′ is preferably designed in such a way that the sealing layer remains uncompromised by the pre-stamping or pre-punching 18′. It is optionally possible in addition or as an alternative for a seal to be arranged between the crimp cap 180 and the flange 4. It is conceivable, for example, for the seal to be designed in the form of a ring or over the entire area (that is to say continuous, in particular in the form of a disk). The seal can be introduced into the crimp cap 180, in particular sealed, adhesively bonded and/or foamed. With the aid of the seal, additionally improved sealing is possible. It is furthermore conceivable for a protective lacquer to be applied to the upper side of the crimp cap 180, the side which faces away from the cartridge 2.

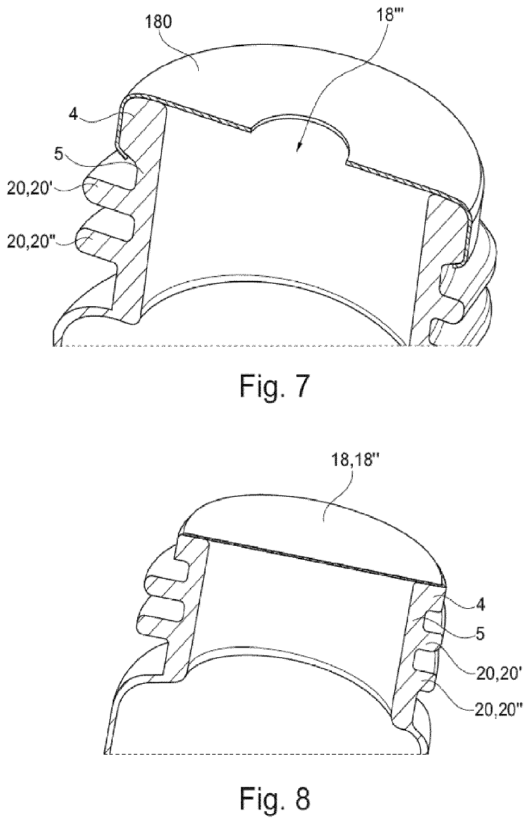

FIG. 7 shows a schematic perspective sectional view of a cartridge 2 for a cartridge system 1 according to one illustrative embodiment of the present invention. As in the exemplary embodiment illustrated in FIG. 5, the sealing element 18 or a sealing body of the sealing element 18 is designed as a crimp cap 180. The sealing element 18, that is to say the crimp cap 180, comprises a central through-opening 18′″, in particular a bore. Alternatively, it is also conceivable for the through-opening 18′″ to be designed to be offset from the center of the sealing element 18. The through-opening 18′″ of the sealing element 18 is closed by a sealing film 18″ (not illustrated). In this case, the sealing film 18″ can be connected to the crimp cap 180 on the lower side of the crimp cap 180, the side facing in the direction of the cartridge 2, or on the upper side of the crimp cap 180, the side facing away from the cartridge 2. In the initial state of the cartridge system 1, the sealing film 18″ thus closes the through-opening 18″. In the event of contact between the sealing element 18 and a piercing spike 73, the sealing film 18″ is pierced. An advantageously defined opening can thus be produced in the sealing element 18. It is conceivable for a sealing layer, in particular a lacquer and/or a laminated or coextruded plastic, preferably comprising polypropylene and/or some other plastic, to be arranged on the lower side of the crimp cap 180, the side facing in the direction of the cartridge 2. In particular, the sealing layer is arranged between the flange 4 and the crimp cap 180. It is optionally possible in addition or as an alternative for a seal to be arranged between the crimp cap 180 and the flange 4. It is conceivable, for example, for the seal to be designed in the form of a ring or over the entire area (that is to say continuous, in particular in the form of a disk). The seal can be introduced into the crimp cap 180, in particular sealed, adhesively bonded and/or foamed. With the aid of the seal, additionally improved sealing is possible. It is furthermore conceivable for a protective lacquer to be applied to the upper side of the crimp cap 180, the side which faces away from the cartridge 2. As an alternative to the crimp cap 180 shown, a design of the sealing element 18 as a screw cap would also be conceivable. To improve sealing, both variants (crimp cap 180 or screw cap) can additionally be sealed in the direction of the flange 4 and/or in the direction of the crimp cap 180 or screw cap.

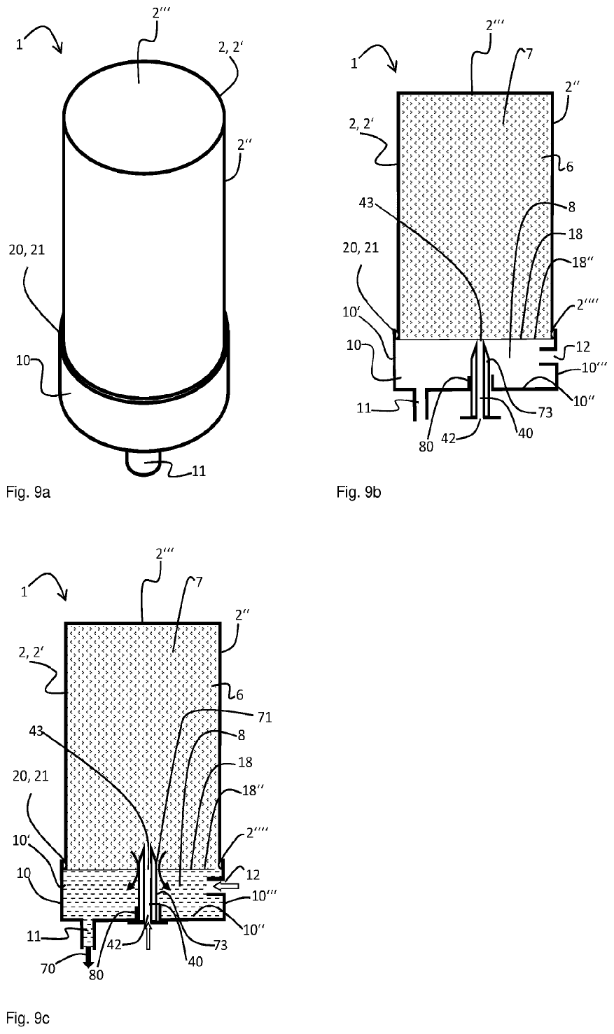

FIG. 8 shows a schematic perspective sectional view of a cartridge 2 for a cartridge system 1 according to a further illustrative embodiment of the present invention. In this case, the opening 90 of the cartridge 2 is closed by a sealing element 18 designed as a sealing film 18″. The sealing film 18″ is secured on the upper side 4′ of the flange 4, in particular to the end face 4″ of the flange 4. In this case, an edge region of the sealing film 18″ is arranged on the upper side 4′ of the flange 4 and is secured on the flange 4 in this edge region. The edge region of the sealing film 18″ is preferably secured on the upper side 4′ of the flange by welding, in particular by inductive welding. However, it is also possible to use other methods, in particular adhesive bonding methods, for securing the sealing film 18″ on the flange 4. A sealing element 18 designed as a sealing film 18″ can be designed in a particularly cost-saving manner and can be used particularly advantageously for beverage substances 7 for which a comparatively low pressure, in particular a low overpressure or no overpressure, within the reservoir 6 is sufficient. The sealing film 18″ is designed, in particular, as a plastic film, metal film (in particular aluminum film) or as a multilayer film of plastic and/or aluminum (and/or one or more further metals). As shown in FIG. 8, it is possible for the sealing film 18″ to project beyond the flange 4 at the periphery. Particularly advantageous tolerance compensation can thereby be achieved.

As can be seen in FIGS. 5 to 8, it is a further particular advantage that the flange 4 can be used for the attachment of different sealing elements 18, in particular without structural changes to the cartridge and being necessary. This makes possible particularly cost-effective and versatile use of a cartridge design since combination with different sealing elements 18 and methods of securing the sealing elements 18 on the cartridge 2 becomes possible, thus enabling the cartridge to be used to particular advantage for beverage substances 7 having different requirements.

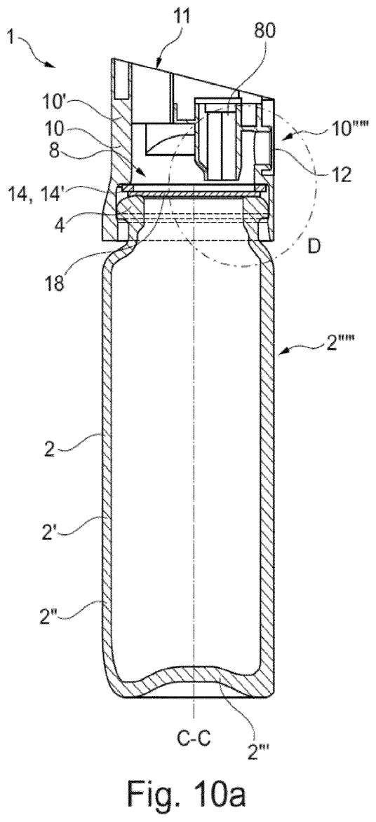

FIGS. 9a, 9b, and 9c show a perspective illustration, a schematic sectional view, and the general operating principle of a cartridge system 1 according to one illustrative embodiment of the present invention.

The cartridge system 1 depicted is intended for insertion into a beverage preparation machine (not illustrated) in order to prepare a beverage 70. For this purpose, the cartridge system 1 has the cartridge 2, which is filled with a beverage substance 7, and a cartridge receptacle 10 connected to the cartridge 2. Within the beverage preparation machine, a corresponding beverage 70 is created with the aid of the beverage substance 7 and an additional water source, referred to as fluid source 41 in the following text. The cartridge 2 is in this case preferably filled with a pre-portioned quantity of beverage substance 7 which is necessary for creating a specific drinking portion, for example a drinking glass filling of the desired beverage 70. The beverage substance 7 is, in particular, a liquid and carbonated beverage concentrate in the form of syrup.

In principle, there is in particular a plurality of different cartridge systems 1 available, the cartridges 2 or reservoirs 6 of which are filled with different beverage substances 7 for making different beverages 70. When the user of the system 1 wishes to drink a particular beverage 70, all he needs to do is choose, from the plurality of different cartridge systems 1, that cartridge system 1 which contains the corresponding beverage substance 7 for making the desired beverage 70, insert it into a retaining unit of the beverage preparation machine and start the beverage making process at the beverage preparation machine, for example by pressing a start button, by touching a touch sensitive display in an appropriate manner, by gesture or voice control, or by means of a suitable application on a cell phone. It is also conceivable for the beverage making process to start automatically when the insertion of a new cartridge system 1 into the retaining unit is detected. In each of the abovementioned cases, the desired beverage 70 is then produced automatically, conveyed into a drinking vessel and thus provided to the user. Subsequently, the used-up cartridge system 1 is removed and disposed of. The beverage preparation machine is now ready once again to be filled with any desired new cartridge system 1 in order to produce a further beverage 70.

The beverage substance 7 comprises preferably liquid premixing constituents for soft drinks, such as caffeinated, carbonated, fruity and/or sugary sodas and juices, beer (mixed) drinks, or other alcoholic or nonalcoholic (mixed) drinks.

The cartridge system 1 comprises a cartridge 2, for example a cartridge 2 designed according to one or more of FIGS. 1 to 8. The region around the flange 4 of the cartridge is not illustrated in detail in FIGS. 9a to 9c.

The cartridge 2 is connected fixedly or reversibly to the cartridge receptacle 10. The cartridge receptacle 10 is connected to the cartridge 2, in particular after the production of the main body 2′, after the filling of the cartridge 2 with the beverage substance 7 and after and/or during the closing of the reservoir 6 by the application of the sealing element 18. For this purpose, the cartridge wall 2″ preferably has encircling connecting means 20, in particular in the form of one or more encircling latching beads 20′, 20″ or latching grooves. The cartridge receptacle 10 optionally has mating connecting means 21 complementary to the connecting means 20, in particular in the form of one or more encircling latching beads and/or latching grooves, which latch into the connecting means 20 when the cartridge 2 is connected to the cartridge receptacle 10. The connecting means 20 and/or further elements preferably form a twist prevention means for the cartridge 2 and the cartridge receptacle 10. It is conceivable for the cartridge wall 2″ and the cartridge receptacle 10 additionally to be adhesively bonded, welded and/or pressed together. It is conceivable, in particular, for an additional seal to be formed between the cartridge 2 and the cartridge receptacle 10, for example with the aid of an O-ring which is arranged, in particular, in the region of the connecting means 20, in particular inserted between the latching beads 20′, 20″. Alternatively or in addition, the additional sealing can be accomplished, for example, by embodying the cartridge receptacle 10 with the aid of a two-component plastic. As a result, an advantageous seal can preferably also be achieved if the cartridge wall has a comparatively large tolerance of, for example, ±0.3 mm.

The cartridge 2 is preferably designed in such a way that it can withstand an internal pressure of up to 12 bar, preferably up to 10 bar, particularly preferably up to 8 bar and very particularly preferably up to 6 bar, without bursting (at a temperature of 20° C. and an external pressure of 1 bar). The reservoir 6 preferably comprises a volume of between 10 and 500 milliliters, particularly preferably between 30 and 90 milliliters and very particularly preferably substantially 60 milliliters.

The cartridge receptacle 10 has a mixing chamber 8 which is fluidically connected to the reservoir 6 during the beverage production process, such that, with the aid of a cartridge emptying device of the cartridge receptacle 10, the beverage substance 7 can be transferred at least partially out of the reservoir 6 into the mixing chamber 8. For this purpose, the cartridge emptying device comprises a compressed-air line 40. One end of the compressed-air line 40 is connected to a compressed-air connection 42 which can be connected to a compressed-air source of the beverage preparation machine in order to introduce compressed air into the compressed-air line 40, while the other end leads into a compressed-air outlet which is open in the direction of the reservoir 6 and introduces compressed air into the reservoir 6. The introduction of the compressed air causes the beverage substance 7 to be pushed into the mixing chamber 8. It is conceivable for the compressed-air line 40 to extend in the interior of the piercing spike 73 from the outer compressed-air connection 42, for connection to a compressed-air source, to a compressed-air outlet 43 in the region of a tip of the piercing spike.

A fluid feed 12 of the cartridge receptacle 10, which is supplied by a fluid source of the beverage preparation machine, also leads into the mixing chamber 8. It is conceivable for the fluid feed to have a quick coupling, by way of which the fluid feed 12 can be connected to the fluid source of the beverage preparation machine. The quick coupling can be configured for example such that, when the cartridge system 1 is inserted into the retaining unit, a fluidic connection is automatically established between the fluid source and the mixing chamber 8 via the fluid feed 12. During the beverage production process, fluid, in particular cooled and carbonated drinking water, passes from the fluid feed 12 into the mixing chamber 8 via this fluidic connection. Furthermore, during the beverage production process, beverage substance 7 passes from the reservoir 6 into the mixing chamber 8, as described above. As a result of the beverage substance 7 being blended with the fluid in the mixing chamber 8, the beverage 70 is formed, which then leaves the mixing chamber 8 through a beverage outlet 11.

The cartridge receptacle 10 has the beverage outlet 11, through which the beverage 70 produced within the mixing chamber 8 leaves the mixing chamber 8, and is conveyed in particular directly into the drinking vessel (not depicted), i.e. without parts of the beverage preparation machine coming into contact with the beverage 70. In this way, back-contamination of the beverage preparation machine is prevented. The drinking vessel is arranged in particular directly beneath the beverage outlet 11.

Following completion of the beverage making process, the cartridge system 1 is removed from the retaining unit, such that the beverage production machine can be fitted with a new and unused cartridge system 1. The cartridge receptacle 10 can optionally be reused by being separated from the used cartridge 2 by releasing the latching connection, and being clip-fastened onto a new cartridge 2. It is conceivable for the cartridge 2 also to be reusable. In particular, it is conceivable that the cartridge can be filled with a new beverage substance 7 and sealed with a sealing element 18.

To establish the fluidic connection between the reservoir 6 and the mixing chamber 8, the cartridge receptacle 10 has a spike guide 80, in which a piercing spike 73 is displaceably mounted. The sealing element 18 is perforated by the displaceable piercing spike 73 being transferred between a retracted position, in which the piercing spike 73 is away from the sealing element 18 (cf. FIG. 9b), and an extended position, in which the piercing spike 73 pierces the sealing element 18 (cf. FIG. 9c) and projects into the reservoir 6.

The outer wall of the piercing spike 73 is provided with the plurality of lateral channels 71 for conveying the beverage substance 7 from the reservoir 6 in the direction of the mixing chamber 8 when the sealing element 18 is pierced. The lateral channels 71 are configured in the form of grooves that are open on one side and extend parallel to one another. Following the piercing of the sealing element 18, the lateral channels 71 become fluidically connected to the reservoir 6, such that the beverage substance 7 can flow around the edges of the pierced sealing element 18 in the direction of the mixing chamber 8.

The cross section of the lateral channels 71 and/or the number of the lateral channels 71 is in this case preferably adapted to the viscosity of the beverage substance 7, such that the lateral channels 71 control or limit the flow of the beverage substance 7 in the direction of the mixing chamber 8. At a high viscosity, a plurality of lateral channels 71 and/or lateral channels 71 with a relatively large cross section are used, while, at a lower viscosity, fewer lateral channels 71 and/or lateral channels 71 with a smaller cross section are provided.

Also integrated into the piercing spike 73 is the compressed-air line 40, which acts as the cartridge emptying device. The compressed-air line 40 leads into the reservoir 6 at the end of the piercing spike 73 when the piercing spike 73 is in the extended position.

On a side of the piercing spike 73 that is in particular remote from the reservoir 6, the compressed-air connection 42 is formed, which is thus accessible from outside the cartridge receptacle 10 and is connectable to the compressed-air source of the beverage preparation machine.

Preferably, the piercing spike 73 is transferred from the retracted position into the extended position during or after the insertion of the cartridge system 10 into the beverage preparation machine or after the starting of the beverage making process, preferably by a fixed release element of the retaining unit, against which the piercing spike 73 is pushed. The piercing spike 71 is preferably configured as a plastic part and particularly preferably as an injection-molded plastic part.

It is preferably conceivable for both the fluid source and the compressed-air source to be coupled directly to the fluid feed 12 and to the compressed-air connection 42, respectively, as soon as the cartridge system 1 is inserted into the beverage preparation machine or a beverage making process is started, and in particular before the sealing element 18 is pierced. In this way, back-contamination in the direction of the beverage preparation machine is effectively avoided because the fluid feed 12 and the cartridge emptying device are under overpressure, in particular immediately upon insertion of the cartridge system 1, and this prevents the beverage substance 7 from traveling in the direction of the fluid source and compressed-air source, respectively. The beverage substance 7 can thus move only in the direction of the mixing chamber 8 from the reservoir 6 (see FIG. 9c) as soon as the sealing element 18 is opened.

The cartridge receptacle 10 comprises a basic structure 10′ with a cup-shaped configuration. The open side of this cup-shaped configuration points in the direction of the cartridge 2 and at least partially accommodates the cartridge 2, in particular the edge 2″″ of the cartridge wall 2″ with the flange 4 and the connecting means 20. On an opposite bottom side 10″, the basic structure 10′ has the beverage outlet opening 11 and the outwardly open spike guide 80. The fluid feed 12 is formed on a side wall 10′″ of the basic structure 10′. In particular, the basic structure 10′ is configured as a plastic part and particularly preferably as an injection-molded plastic part.

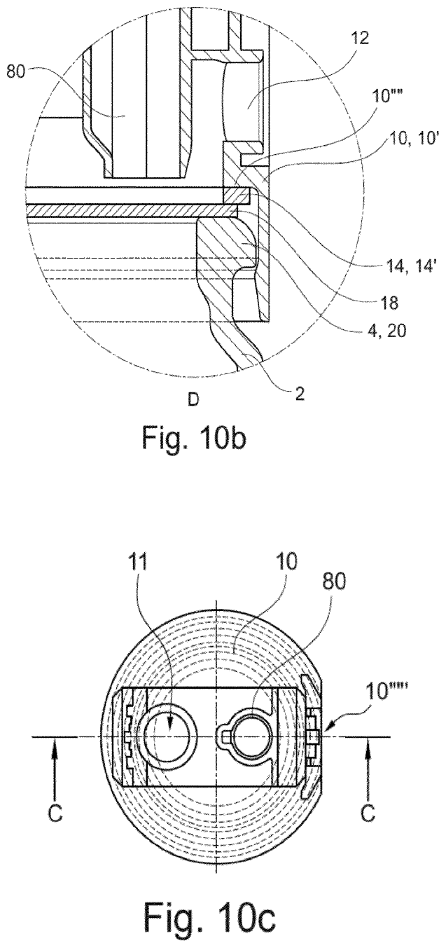

FIG. 10a shows a schematic sectional view of a cartridge system 1 according to one illustrative embodiment of the present invention. The cartridge system 1 comprises the cartridge 2 and the cartridge receptacle 10, which is designed as a mixing cap with a mixing chamber 8. It is possible, as illustrated, for the cartridge 2 to have a flattened portion 2′″″ on one side on its circumference and for the cartridge receptacle 10 likewise to have a flattened portion 10′″″ on one side. With the aid of the flattened portions 2′″″, 10′″″, an advantageously definable orientation of the cartridge 2 and of the cartridge receptacle 10 in the beverage preparation machine is possible, in particular. In this way and/or with the aid of further means, a twist prevention means can be formed between the cartridge 2 and the cartridge receptacle 10. The cartridge 2 comprises the flange 4. The sealing element 18 is secured on the flange 4, for example by adhesive bonding, sealing, welding and/or crimping. Here, the sealing element can comprise a sealing film and/or a semi-rigid or rigid sealing body, for example a crimp cap. The sealing element 18 is secured leaktightly on the cartridge 2, in particular with the aid of the flange 4, preferably with the aid of the end face of the flange 4. In the embodiment shown in FIG. 10a, the flange 4 is simultaneously designed as a connecting means 20 for connecting the cartridge 2 and the cartridge receptacle 10. In this case, the connecting means 20 of the cartridge 2 is thus, in particular, not an element separate from the flange 4. The cartridge receptacle 10 is pressed and/or latched onto the cartridge 2, in particular with the aid of the flange 4. It is possible for the cartridge receptacle 10 to have a mating connecting means 21 complementary to the flange 4 for this purpose. An additional seal is preferably formed between the cartridge 2 and the cartridge receptacle 10 with the aid of a sealing means 14. The sealing means 14 seals the connection between the cartridge 2 and the cartridge receptacle 10 in a particularly advantageous way, ensuring that no liquids emerge at the transition between the cartridge 2 and the cartridge receptacle 10 during the preparation of a beverage. The sealing means 14 advantageously also serves to compensate for tolerances. This tolerance compensation is of particular advantage when a glass cartridge 2 is used.

FIG. 10b shows an enlarged illustration of the region of the cartridge receptacle 10 and of the cartridge 2 which is marked with the letter “D” in FIG. 10a. The sealing means 14 is arranged between the cartridge 2 and the cartridge receptacle 10. In particular, the sealing means 14 is arranged partially or completely between a projection region 10″″ of the cartridge receptacle 10, said projection region being formed inwardly over the end face 4″ or upper side 4′ of the flange 4, and the sealing element 18. In the illustrated embodiment, the sealing means 14 is designed as a sealing ring 14′, in particular as an O-ring. The sealing ring 14′ thus rests above the flange 4 on the sealing element 18 and/or on the upper side 4′ of the flange 4. As an alternative to the use of an O-ring, a full-area design of the sealing means 14 with a bore/aperture for the piercing spike 73 would also be conceivable. Alternatively, a full-area design of the sealing means 14 without a bore/aperture for the piercing spike 73 would also be conceivable. Alternatively or in addition to the sealing ring 14′, other sealing means 14 for sealing the mixing chamber 8, that is to say in particular the transition of the cartridge 2 to the cartridge receptacle 10, are also conceivable. For example, it is possible for the sealing element 18 to have a foamed region or a foam on its upper side facing away from the cartridge 2 (that is to say the side facing the cartridge receptacle 10, in particular the projection region 10″″), which provides for the additional sealing.

FIG. 10c shows a schematic plan view of the cartridge receptacle 10 according to the embodiment illustrated in FIGS. 10a and 10b.

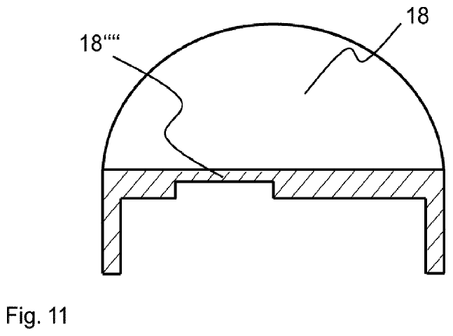

FIG. 11 shows a schematic perspective sectional view of a sealing element 18 according to one illustrative embodiment of the present invention. The sealing element 18 is designed as a plastic cap and comprises one or more plastics. The plastic cap can be formed with the aid of injection molding, for example. It is conceivable here for the plastic cap to be designed as a crimp cap, latching cap or screw cap, i.e. for it to be possible, for example, for it to be crimped, latched or screwed onto a cartridge. The sealing element 18, in particular the plastic cap, has a weakening 18″″ for the passage of the piercing spike 73. The weakening 18″″ is, in particular, a region of the plastic cap which has a reduced thickness in comparison with the adjacent regions of the plastic cap. The weakening 18″″ is preferably produced during the formation of the plastic cap, for example during injection molding, as a thinned region of the plastic cap, and therefore no further post-processing of the plastic cap is necessary to produce the weakening. The plastic cap shown in FIG. 11 can be combined as a sealing element 18, for example with the various embodiments of sealing means 14 described above, e.g. with an annular or full-area sealing means 14 which is designed as a separate insert or with the aid of two-component injection molding as part of the sealing element 18 or as part of the cartridge receptacle 10.

### LIST OF REFERENCE SIGNS

1 Cartridge system
2 Cartridge
2′ Main body
2″ Cartridge wall
2′″ Cartridge base
2″″ Edge of the cartridge wall
2′″″ Flattened portion of the cartridge
4 Flange
4′ Upper side of the flange
4″ End face of the flange
4′″ Height of the flange
4″″ Outer side of the flange
4′″″ Lower side of the flange
5 Secondary region
6 Reservoir
7 Beverage substance
8 Mixing chamber
9 Indentation
Cartridge receptacle
10′ Basic structure
10″ Bottom side
10′″ Side wall of the basic structure
10″″ Projection region
10′″″ Flattened portion of the cartridge receptacle
11 Beverage outlet
12 Fluid feed
14 Sealing means
14′ Sealing ring
18 Sealing element
18′ Pre-punching of the sealing element
18″ Sealing film
18′″ Through-opening of the sealing element
18″″ Weakening of the sealing element
20 Connecting means
20′ Latching bead
20″ Further latching bead
20′″ Spacing of the connecting means
21 Mating connecting means
40 Compressed-air line
42 Compressed-air connection
43 Compressed-air outlet
71 Lateral channel
70 Beverage
73 Piercing spike
80 Spike guide
90 Opening
90′ Diameter of the opening
91 Outer diameter of the flange
100 Central axis of extent
110 Radial axis
180 Crimp cap
K Lower opening angle of the flange
L Upper opening angle of the flange
M First radius of curvature
N Second radius of curvature
O Third radius of curvature
P Fourth radius of curvature

1. A cartridge system for making a beverage, wherein the cartridge system can be inserted into a beverage preparation machine, the cartridge system comprising:
a) a cartridge comprising a reservoir filled with a beverage substance; and
b) a cartridge receptacle connected to the cartridge, wherein the cartridge receptacle comprises:
a mixing chamber, which can be brought into fluidic connection with the reservoir; and
a fluid feed opening into the mixing chamber;
wherein the cartridge has a cartridge wall;
wherein the cartridge wall comprises a flange for mounting a sealing element; and
wherein the flange is designed as a radially outward-projecting region of the cartridge wall.

2. The cartridge system as claimed in claim 1, wherein the flange is designed as a mouth region of the cartridge wall at an edge of the cartridge wall.

3. (canceled)

4. The cartridge system as claimed in claim 1, wherein the flange is formed in a fully circumferential manner on the cartridge wall around an entire circumference of the cartridge wall.

5. The cartridge system as claimed in claim 1, wherein the flange is formed with the aid of a thickened region of the cartridge wall.

6. The cartridge system as claimed in claim 1, wherein the cartridge comprises a main body of a cup-shaped design, wherein the main body is formed with the aid of the cartridge wall, which is closed on one side by a cartridge base, wherein the main body comprises the reservoir.

7. The cartridge system as claimed in claim 6, wherein the cartridge wall comprises a secondary region which is arranged adjacent to the flange in a direction of the cartridge base, wherein the cartridge wall has a smaller wall thickness in the secondary region than in a region of the flange.

8. The cartridge system as claimed in claim 1, wherein the cartridge wall has a connecting means for connecting the cartridge to the cartridge receptacle, wherein the connecting means comprises one or more latching grooves, and/or one or more latching beads, and/or one or more undercuts, and/or an external thread.

9. The cartridge system as claimed in claim 8, wherein the connecting means is formed at a distance from the flange, wherein the connecting means is arranged offset from the flange in a direction of the cartridge base.

10. The cartridge system as claimed in claim 8, wherein the connecting means is arranged adjacent to the secondary region, offset in a direction of the cartridge base.

11. The cartridge system as claimed in claim 1, wherein the connecting means for connecting the cartridge to the cartridge receptacle comprises the flange and/or wherein the flange comprises the connecting means for connecting the cartridge to the cartridge receptacle.

12. The cartridge system as claimed in claim 8, wherein the cartridge receptacle comprises a mating connecting means complementary to the connecting means wherein the mating connecting means includes one or more further latching grooves, and/or one or more further latching beads, and/or one or more further undercuts, and/or an internal thread, wherein the mating connecting means is connected to the connecting means positively, nonpositively, and/or materially.

13. The cartridge system as claimed in claim 6, wherein the cartridge has the sealing element, wherein, the main body is closed off by the sealing element on its side opposite the cartridge base in an initial state of the cartridge system.

14. The cartridge system as claimed in claim 1, wherein the sealing element is crimped, adhesively bonded, sealed, welded, and/or screwed to the cartridge with the aid of the flange.

15. The cartridge system as claimed in claim 1, wherein the sealing element comprises a crimp cap.

16. The cartridge system as claimed in claim 15, wherein the crimp cap comprises a metal.

17.-29. (canceled)

30. A beverage preparation machine, comprising the cartridge system as claimed in claim 1.

31. A process for manufacturing the cartridge system as claimed in claim 1 comprising:
in a first process step, forming the cartridge wall of the cartridge comprising the flange;
in a second process step, securing a sealing element on the cartridge with the aid of the flange; and
in a third process step, connecting the cartridge to the cartridge receptacle

32. The process as claimed in claim 31, wherein, in an intermediate step carried out before the third process step, the cartridge receptacle is produced by injection molding of plastic.

33. The process as claimed in claim 31, wherein a piercing spike is produced in a further intermediate step, which is carried out before or after the third process step, and is introduced into a spike guide of the cartridge receptacle.

34. The process as claimed in claim 31, wherein, in a further intermediate step carried out before the second process step, the sealing element and/or a sealing body of the sealing element are/is punched out and/or cut out of a metal sheet and/or from a sealing film, wherein the sealing film comprises a plastic film, an aluminum film, or a multilayer film of plastic and/or aluminum.

35. The process as claimed in claim 31, wherein the sealing element is formed around the flange of the cartridge wall before or during the second process step.

36.-39. (canceled)
